(19) United States
(12) Patent Application Publication
(10) Pub. No.: US 2012/0301730 A1
(43) Pub. Date: Nov. 29, 2012

(54) BARRIER FILM FOR AN ELECTRONIC DEVICE, METHODS OF MANUFACTURING THE SAME, AND ARTICLES INCLUDING THE SAME

(75) Inventors: Tadao Yagi, Yokohama-si (JP); Yukika Yamada, Yokohama-si (JP); Kenichi Nagayama, Yokohama-si (JP)

(73) Assignee: SAMSUNG ELECTRONICS CO. LTD., Suwon-si (KR)

(21) Appl. No.: 13/478,787

(22) Filed: May 23, 2012

(30) Foreign Application Priority Data
May 23, 2011 (JP) 2011-114525
May 23, 2011 (JP) 2011-114526
Feb. 23, 2012 (KR) 10-2012-0018654

(51) Int. Cl. B32B 9/04; B32B 27/06; B32B 19/00; B05D 3/06; B05D 3/00; B05D 3/10; B05D 3/04; B32B 19/04; B05D 1/36

(52) U.S. Cl. 428/447; 428/688; 428/689; 428/446; 428/702; 428/454; 427/331; 427/372.2; 427/535; 427/553; 427/551

(57) ABSTRACT

A barrier film for an electronic device, the barrier film including a resin film, and a layer-by-layer stack portion including a first inorganic material layer and a second inorganic material layer which are alternately disposed on the resin film, wherein the first inorganic material layer and the second inorganic material layer are oppositely charged.

### CROSS-REFERENCE TO RELATED APPLICATIONS

This application claims priority to and the benefit of Japanese Patent Application No. 10-2011-0114525, filed on May 23, 2011, and Japanese Patent Application No. 10-2011-0114526, filed on May 23, 2011, and Korean Patent Application No. 10-2012-0018654, filed on Feb. 23, 2012, and all the benefits accruing therefrom under 35 U.S.C. §119, the contents of which are incorporated herein in their entirety by reference.

### BACKGROUND

1. Field

The present disclosure relates to a barrier film for an electronic device, methods of manufacturing the same, and articles including the same.

2. Description of the Related Art

In most current flat panel displays (FPDs) and illumination devices, a device is formed on a glass substrate, and applications using a substrate other than the glass substrate are not common. The reasons thereof include that a glass substrate has high heat resistance and thus it is suitable for forming a driving circuit or member of a display requiring high temperature formation; a glass substrate has a small coefficient of linear expansion and thus a stress applied to a driving circuit or a member may be suppressed so that the rupture of interconnection lines or changes to properties of components may be reduced; glass provides suitable transparency in a visible light region; and because glass provides high gas barrier performance, permeation of oxygen or water vapor from the outside may be blocked, and thus high vacuum conditions may be maintained if desired. Accordingly, a glass substrate having such characteristics is an ideal material.

However, a glass substrate has disadvantages. In detail, a glass substrate is non-flexible, breakable, heavy, deformable, and hard to handle. In particular, when a display panel is manufactured in a larger format to reduce cost, the increased substrate size may result in formation of curvatures and cracks due to the weight of the glass substrate. Also, for mobile applications, a glass substrate may not be suitable in an application that calls for the substrate to be bent for transport or storage, such as in a foldable device. In addition, a decrease in weight is an important factor for mobile applications requiring high portability. Also, a glass substrate easily cracks due to impact, and when dropped, a device including the glass substrate may be easily damaged. Accordingly, the glass substrate is not suitable for use in many mobile applications.

Flexible substrate materials for display devices having the same high heat resistance, coefficient of linear expansion, and gas barrier performances as those of a glass substrate are being developed to overcome such disadvantages of the glass substrate. For example, as a substrate having a high gas barrier performance and flexibility, a substrate in which an organic-inorganic hybrid material is coated on an extremely thin glass substrate and a substrate in which a multi-layered structure including silicon nitride and carbon nitride is formed on a resin substrate, are being developed. However, these substrates are far from commercialization due to their cost. Accordingly, a substrate in which an organic layer and an inorganic material layer are stacked on a resin substrate or a substrate in which an inorganic material layer and an inorganic material layer are stacked on a resin substrate are being developed.

For example, JP 2007-22075 (hereinafter, referred to as ‘reference 1’) discloses that a clay layer and an inorganic thin film layer are stacked to form a substrate. (All references cited herein are incorporated by reference in their entirety.) Also, JP 2007-65644 (hereinafter, referred to as ‘reference 2’) discloses that a reinforcing layer or a leveling layer is formed between a clay layer and an inorganic thin film layer. References 1 and 2 disclose that a clay layer and an inorganic thin film layer are stacked to form a barrier layer having gas barrier performance.

As another example, WO 2004/024989 (hereinafter, referred to as ‘reference 3’) discloses that when a barrier layer is formed by stacking clay layers, an organic layer having a thickness of a few nanometers to several tens of nanometers is formed between the respective clay layers to attach the clay layers to each other by an electrostatic force.

As another example, JP 2003-41153 (hereinafter, referred to as ‘reference 4’) discloses that a layered compound, such as clay, and metal alkoxide are dispersed using a sol-gel method to form a film having gas barrier performances.

However, regarding the technology of reference 1, when a composition and a process are taken into consideration, an adhesion force between the clay layer and the inorganic thin film layer is low and the clay layer and the inorganic thin film layer may be separated from each other and thus, a highly reliable film may not be obtained. In response, reference 2 discloses that the adhesion force between the clay layer and the inorganic thin film layer is increased by forming a buffer layer or a reinforcing layer between the clay layer and the inorganic thin film layer. Even in this case, however, a film structure and a manufacturing process may be complicated.

Also, according to reference 3, clay layers are attached to each other by an electrostatic force by an organic layer and thus, an adhesion force between the respective clay layers is high and a highly reliable film may be obtained. However, the organic layer does not have a barrier performance and has low heat resistance.

Also, according to reference 4, clay or an alkoxide are dispersed to form a film. In fact, however, it is very difficult to disperse clay in such an amount that may allow a formed film to have a high barrier performance.

Also, as a flexible substrate for an electronic device, a barrier film in which a barrier layer is formed on a resin film is used. Typically, barrier films are used to package food products. Now, they are further used for electronic devices. Accordingly, there is a need to substantially improve barrier performances.

US 2004/053037 (hereinafter, referred to as ‘reference 5’) discloses a barrier film. The barrier film of reference 5 is formed by stacking a clay layer formed from clay particles, and a cationic resin by layer-by-layer adsorption. However, because the cationic resin included in the barrier film of reference 5 has high gas permeability, the cationic resin acts as a passageway for a gas, such as water vapor. Accordingly, the respective clay layers of the barrier film of reference 5 may have insufficient barrier performance. To obtain sufficient barrier performance, the stack number of the clay layers may be increased. However, this method makes the manufacturing process complicated and also a formed barrier becomes thick. Thus there remains a need for an improved flexible substrate.

### SUMMARY

Provided is a barrier film having a high gas barrier performance, strong interlayer adhesion, and high reliability.

Additional aspects, features, and advantages will be set forth in part in the description which follows and, in part, will be apparent from the description.

According to an aspect, a barrier film for an electronic device includes: a resin film; and a layer-by-layer stack portion including a first inorganic material layer and a second inorganic material layer which are alternately disposed on the resin film, wherein the first inorganic material layer and the second inorganic material layer oppositely charged.

The first inorganic material layer may include a charged inorganic compound that has either a positive or a negative charge, and the second inorganic material layer may include a charged inorganic layered compound that has a charge opposite to that of the first inorganic material layer.

The first inorganic compound may include at least one element selected from silicon, aluminum, titanium, and zirconium.

The inorganic compound may include an onium salt.

The onium salt may include an ammonium salt.

The first inorganic material layer may include a hydrolysis product of at least one selected from alkoxysilane, metal alkoxide, polysilazane, and alkali silicate.

The first inorganic material layer may include a substituent that does not chemically react with an alkoxysilane, a metal alkoxide, a polysilazane, and an alkali silicate.

The inorganic layered compound may include at least one selected from a clay mineral, a phosphate compound, and a layered double hydroxide compound.

The layer-by-layer stack portion may include a plurality of layers, wherein an innermost layer that contacts the resin film and an outermost layer that is distal to the resin film may be the first inorganic material layers.

The first inorganic material layer may include a charged tabular inorganic particle, and the second inorganic material layer may include a charged second inorganic compound that has a charge opposite to that of the charged tabular inorganic particle.

The second inorganic material layer may include at least one selected from a metal ion, a metal compound ion, and a tabular inorganic particle.

The metal ion may include an ion of at least one metal selected from aluminum, magnesium, potassium, and a polyvalent transition metal. The metal ion may strongly be attached to the first inorganic material layer due to a coulombic force so that performance of the barrier film is improved.

The polyvalent transition metal may include at least one selected from iron, cobalt, and manganese. An ion of the polyvalent transition metal may be attached to the first inorganic material layer due to a coulombic force so that the performance of the barrier film is improved.

A metal that constitutes the metal compound ion may include at least one selected from tungsten, vanadium, molybdenum, and titanium. The metal compound ion may be attached to the first inorganic material layer due to a coulombic force so that the performance of the barrier film is improved.

The second inorganic material layer may include an charged second tabular inorganic particle that is a product of layer-separating a layered double hydroxide compound. The second tabular inorganic particle may be attached to the first inorganic material layer due to a coulombic force so that the performance of the barrier film is improved. Also, the second tabular inorganic particle may prevent the gas permeation. From this aspect, barrier performance of the barrier film may be improved.

The first inorganic material layer may include a charged first tabular inorganic particle that is negatively charged, and the second inorganic material layer may be positively charged.

The first tabular inorganic particle may be obtained by layer-separating at least one selected from a clay mineral and zirconium phosphate. Accordingly, the first tabular inorganic particle may prevent the gas permeation. From this aspect, barrier performance of the barrier film is improved.

The clay mineral may include at least one selected from mica, bermiculite, montmorillonite, iron montmorillonite, beidellite, saponite, hectorite, and stevensite. Due to the inclusion, the tabular inorganic particle may prevent the gas permeation. From this aspect, barrier performance of the barrier film is improved.

The clay mineral may include montmorillonite. Montmorillonite may easily be layer-separated, and from this aspect, the first tabular inorganic particle is easily formed.

The first tabular inorganic particle may be obtained by layer-separating zirconium phosphate. Zirconium phosphate may easily be layer-separated, and from this aspect, the first tabular inorganic particle is easily formed.

The barrier film may further include an adsorption film that is disposed on the resin film to allow the resin film to adsorb on to the layer-by-layer stack portion. By doing so, the layer-by-layer stack portion and the resin film may be strongly adsorbed to each other and thus, barrier performance may be further enhanced.

The adsorption layer may include at least one selected from silica and alumina. By doing so, the layer-by-layer stack portion and the resin film may be strongly adsorbed to each other and thus, barrier performance may be further enhanced.

The adsorption layer may be charged with a charge opposite to that of a layer of the layer-by-layer stack portion, the layer of the layer-by-layer stack portion being adsorbed to the adsorption layer. By doing so, the layer-by-layer stack portion and the resin film may be strongly adsorbed to each other and thus, barrier performance may be further enhanced.

The adsorption layer may be charged by using a silane coupling agent. By doing this, the adsorption layer is more strongly charged.

The barrier film may be a substrate for an electronic device.

Also disclosed is a method of forming a barrier film, the method including: combining a framework forming material and a sol-gel material having a substituent capable of forming an onium ion to form a first solution; disposing the first solution on a substrate to form a first inorganic material layer; dispersing a clay in water to form a second solution; contacting the first inorganic layer with the second solution to form a second inorganic material layer on the first inorganic material layer; and washing the first and the second inorganic material layers to form the barrier film.

Also disclosed is a method of forming a barrier film, the method including: treating a surface of a substrate to charge the surface; dispersing a tabular inorganic particle to prepare a dispersion; disposing the dispersion on the substrate to form a first inorganic material layer; forming a binder particle solution including a positively charged metal ion, a positively charged metal compound ion, and a positively charged tabular inorganic particle; and contacting the first inorganic material layer and the binder particle solution to dispose a second inorganic material layer on the first inorganic material layer; and washing the first inorganic material layer and the second inorganic material layer to form the barrier film.

### BRIEF DESCRIPTION OF THE DRAWINGS

These and/or other aspects will become more apparent and more readily appreciated from the following description of the embodiments, taken in conjunction with the accompanying drawings in which:

FIG. 1 is a schematic illustration of an embodiment of a barrier film for an electronic device;

FIG. 2 is a schematic illustration of an adhesion state between a first inorganic material layer and a second inorganic material layer illustrated in FIG. 1;

FIG. 3 shows an atomic force microscope image of an Example from which the stacking of the second inorganic material layer on the first inorganic material layer is confirmed;

FIG. 4 is a schematic illustration of an embodiment of a barrier film for an electronic device;

FIG. 5 is an schematic illustration of an adhesion state between the first inorganic material layer and the second inorganic material layer illustrated in FIG. 4;

FIG. 6 is a graph of film thickness (micrometers, μm) versus addition ratio of trifunctional compound (mass percent) showing a relationship between a addition ratio of alkoxysilane, metal alkoxide, polysilazane, and alkali silicate, each of which includes a substituent that is substantially chemically inert, and film thickness;

FIG. 7 is a cross-sectional view of another embodiment of a barrier film for an electronic device; and

FIGS. 8A-8D are cross-sectional views illustrating an embodiment of a method of manufacturing the barrier film for an electronic device of FIG. 7.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkoxy” means a C1 to C30 alkyl group that is linked via an oxygen (i.e., —O-alkyl). Nonlimiting examples of C1 to C30 alkoxy groups include methoxy groups, ethoxy groups, propoxy groups, isobutyloxy groups, sec-butyloxy groups, pentyloxy groups, iso-amyloxy groups, and hexyloxy groups.

“Alkyl” means a straight or branched chain saturated aliphatic hydrocarbon having the specified number of carbon atoms, specifically 1 to 12 carbon atoms, more specifically 1 to 6 carbon atoms. Alkyl groups include, for example, groups having from 1 to 50 carbon atoms (C1 to C50 alkyl).

“Aryl,” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof.

Hereafter, barrier films for an electronic device according to one or more embodiments are described below with reference to the attached drawings. In the drawings, the same reference numerals denote the same elements.

### First Embodiment

First, a first barrier film 100 for an electronic device according to an embodiment is further described below.

### Structure of the First Barrier Film 100

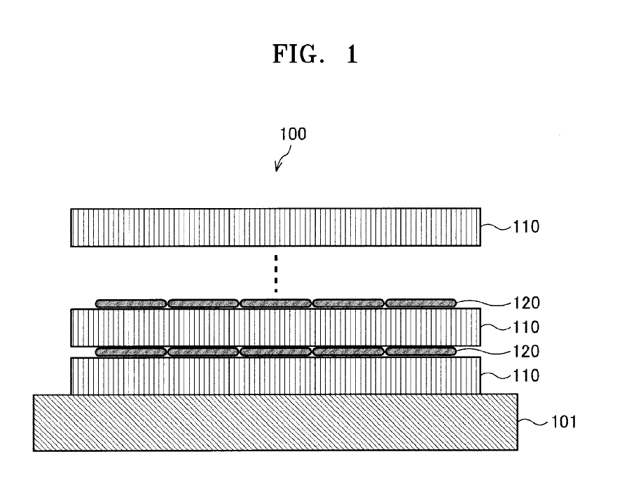

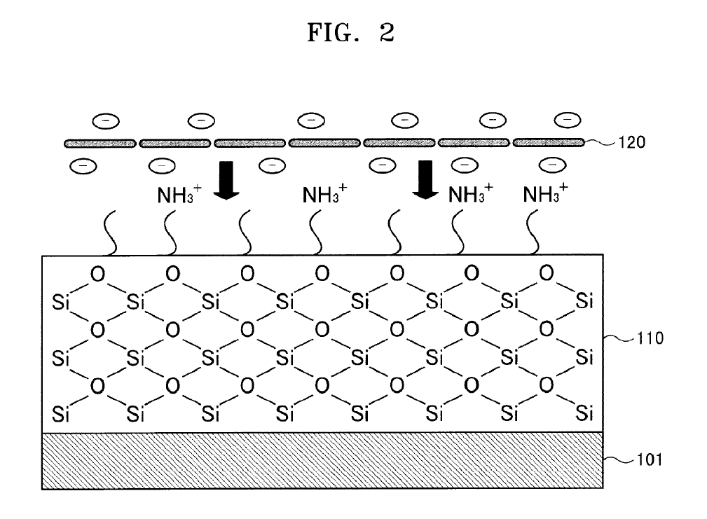

Referring to FIGS. 1 and 2, the structure of an embodiment of the first barrier film 100 is described. FIG. 1 is an explanatory diagram schematically illustrating the structure of an embodiment of the first barrier film 100 for an electronic device. FIG. 2 is an explanatory diagram schematically illustrating an adhesion state between a first inorganic material layer 110 and a second inorganic material layer 120 illustrated in FIG. 1.

The first barrier film 100 of FIGS. 1 and 2 is a substrate that can be used in a flat panel display (FPD) or an illumination device, and includes a resin film 101, the first inorganic material layer 110 and the second inorganic material layer 120. For example, the first barrier film 100 is a substrate that includes a layered film including a plurality of layers disposed on the resin film 101. The layered film can comprise one or more of the first inorganic material layer 110 disposed alternately with one or more of the second inorganic material layer 120. That is, the layered film may include one or more of the first inorganic material layer 110 and one or more of the second inorganic material layer 120, and the first inorganic material layer 110 and the second inorganic material layer 120 may be alternately stacked. Any number of the first inorganic layer 110 and any number of the second inorganic layer 120 may be included in the layer film, so long as the desirable properties of the barrier film are not adversely affected. The alternately stacked first inorganic material layer 110 and second inorganic material layer 120 may have the first inorganic material layer 110 or the second inorganic material layer 120 as the terminal layer. For example, as shown in FIG. 1, the barrier film may comprise an n^{th} first inorganic layer 110n on the upper-most second inorganic material layer 120, e.g., the inorganic layer distal to the resin film 101 may be the first inorganic layer 110. In another embodiment, the inorganic layer distal to the resin film 101 is a second inorganic layer 120.

As described above, in the first barrier film 100, the first inorganic material layer 110, and the second inorganic material layer 120 are alternately disposed on the resin film 101. As illustrated in FIG. 2, an ionized form of an inorganic layered compound is positively or negatively charged (e.g., negatively charged, in the embodiment illustrated in FIG. 2), and the ionized inorganic layered compound is electrostatically attached to the first inorganic material layer 110 which is oppositely charged (e.g., positively charged, in the embodiment illustrated in FIG. 2). As a result, the first inorganic material layer 110 and the second inorganic material layer 120 may be strongly attached to each other and thus the first inorganic material layer 110 and the second inorganic material layer 120 may be reliability bonded. Hereinafter, the resin film 101, the first inorganic material layer 110, and the second inorganic material layer 120 are described in further detail.

### Resin Film 101

The resin film 101 is, as described above, a film (e.g. a substrate) on which the layered film including the first inorganic material layer 110 and the second inorganic material layer 120 is formed. The resin film 101 may be a known film-shaped substrate comprising a polymer suitable for the intended use of the barrier film. The resin film may comprise an epoxy, ethylene propylene diene rubber (EPR), ethylene propylene diene monomer rubber (EPDM), polyacetal, polyacrylamide, polyacrylic such as polyacrylic acid, polyacrylonitrile, polyamide including polyamideimide, polyarylene ether, polyarylene sulfide, polyarylene sulfone, polybenzoxazole, polybenzothiazole, polybutadiene and a copolymer thereof, polycarbonate, polycarbonate ester, polyether ketone, polyether ether ketone, polyether ketone ketone, polyethersulfone, polyester, polyimide such as polyetherimide, polyisoprene and a copolymer thereof, polyolefin such a polyethylene and a copolymer thereof, polypropylene and a copolymer thereof, polytetrafluoroethylene, polyphosphazene, poly(alkyl) (meth)acrylate, polystyrene and a copolymer thereof, a rubber-modified polystyrene such as acrylonitrile-butadiene-styrene (ABS), styrene-ethylene-butadiene (SEB), and methyl methacrylate-buadiene-styrene (MBS), polyoxadiazole, polysilazane, polysulfone, polysulfonamide, polyvinyl acetate, polyvinyl chloride, polyvinyl ester, polyvinyl ether, polyvinyl halides, polyvinyl nitrile, polyvinyl thioether, polyurea, polyurethane, polyethylene terephthalate, polyethylene naphthalate, or a silicone. A combination comprising at least one of the foregoing polymers can be used. Polyethylene terephthalate (PET), polyethylene naphthalate (PEN), polyethersulfone (PES), and polyimide (PI), are specifically mentioned.

### First Inorganic Material Layer 110

The first inorganic material layer 110 includes an ionized form of an inorganic compound (that is, a first inorganic material) that is positively or negatively chargeable, i.e., ionizable. In other words, the inorganic compound is not amphoteric, but rather is capable of being either positively ionized or negatively ionized. The inorganic compound may be a major component of the first inorganic material layer 110, and may comprise at least one element selected from silicon, aluminum, titanium, and zirconium. For example, the inorganic compound may comprise at least one compound selected from silicon oxide, silicon nitride, silicon oxynitride, silicon carbide, silicon oxycarbide, aluminum oxide, aluminum nitride, titanium oxide, titanium nitride, zirconium oxide, and zirconium nitride. In detail, at least one compound selected from silicon oxide, silicon nitride, silicon carbide, aluminum oxide, aluminum nitride, titanium oxide, a zirconium oxide may be used.

While not wanting to be bound by theory, it is understood that the first inorganic material layer 110 has a surface that is oppositely charged with respect to the charge of the inorganic layered compound of the second inorganic material layer 120. For example, when a layered structure is formed such that the second inorganic material layer 120 includes a compound having a negative charge, such as when montmorillonite is used as the inorganic layered compound, the first inorganic material layer 110 may comprise an onium cation of an onium salt. In this case, the first inorganic material layer 110 may have or include an onium salt structure that may be positively charged. As used herein, the term “onium salt” refers to a compound formed by coordinatively bonding a compound that has an electron pair that is not otherwise engaged in a chemical bond, and other cationic compounds via the electron pair. For example, a compound having a hetero atom, such as nitrogen (N), phosphorous (P), iodine (I), sulfur (S), oxygen (O), or the like, may form an onium salt.

An onium cation, in general, forms a stable structure with a counter anion. An example of the counter anion may be a halide ion (e.g., a chloride ion, or a bromide ion, or the like), but is not limited thereto, and may also be an anion of an organic acid (e.g., of a carboxylic acid or a sulfonic acid) or an inorganic acid (e.g., of a phosphoric acid or a nitric acid). Examples of the onium salt include an ammonium salt, which comprises an N atom, a phosphonium salt which comprises a P atom, and a sulfonium salt which comprises a S atom. For example, an ammonium salt comprising an N atom may be used. The ammonium salt is an onium salt with high stability. The onium salt may be inorganic or organic, i.e., containing one or more organic ligands, each of which may be the same or different, and may be, for example, a C1-30 organic group as further described below. The onium salt may be an alkylammonium halide (e.g., a C1-C10 alkylammonium halide) or an arylammonium halide (e.g., a C6-C20 arylammonium halide).

The first inorganic material layer 110 may be a layer formed by coating a solution including at least one framework forming material selected from an alkoxysilane, a metal alkoxide, a polysilazane, and an alkali silicate on the resin film 101, followed by drying. Also, a detailed description of a method of forming the first inorganic material layer 110 is further described below.

Herein, a detailed example of the first inorganic material layer 110 is described with reference to FIG. 2. FIG. 2 shows an exemplary embodiment in which an alkoxysilane represented by Si(OR¹)ₙR²₄₋ₙ (wherein R¹ is a C1-10 organic group, and R² is a substituent able to form an onium salt, such as —NR₂, —SR, and —PR₂ wherein each R is the same or different and is hydrogen or an alkyl group, e.g., a C1-10 alkyl group) is included in a solution for forming the first inorganic material layer 110. In an embodiment and while not wanting to be bound by theory, by coating a solution including the alkoxysilane on the resin film 101 and drying the solution, as illustrated in FIG. 2, the first inorganic material layer 110 having a —O—Si—O— framework and also having an ammonium cationic group (e.g., an —NH₃⁺ group) as a site that is positively charged is formed. Also, when the positively charged first inorganic material layer 110 is formed to have an ammonium cation, the second inorganic material layer 120 is formed using an inorganic layered compound (for example, montmorillonite) having a negative charge. As described above, the first inorganic material layer 110 and the second inorganic material layer 120 are oppositely charged, and thus the first inorganic material layer 110 and the second inorganic material layer 120 may be strongly attached to each other by a coulombic force.

Another example of an inorganic compound that can be positively charged is a layered double hydroxide compound which may also be used in the second inorganic material layer 120, and other metal ions may also be used as the inorganic compound that is positively charged. Such a metal ion may be an ion selected from Al, Fe, Mg, K, and the like. A water-soluble compound including such metals, for example, a sulfate, a chloride, a hydroxide, or the like may be dissolved in water to prepare an aqueous solution including the metal ion to provide a solution for forming the first inorganic material layer 110. For example, when Al is used, an aqueous solution of AlK(SO₄)₂ or AlNH₄(SO₄)₂ may be used; when Fe is used, an aqueous solution of FeK(SO₄)₂ may be used; and when K is used, an aqueous solution of at least one selected form KOH, K₂SO₄, and KCl may be used. These metal ions have, in general, a positive charge.

Also, examples of an inorganic compound that can be negatively charged include a clay mineral and a phosphate compound, i.e., a phosphate-based derivative, which also can be used in the second inorganic material layer 120. An oxo acid of a metal may also be used as the inorganic compound that is negatively charged. As the oxo acid of metal, a metal oxo acid compound that is dissolved in water, for example, a sodium salt or an ammonium salt may be used, and for example, at least one selected from NaVO₃, (NH₄)₂MoO₄, (NH₄)₂WO₄, and the like may be used. TiOSO₄ may also be used as an inorganic compound used in the first inorganic material layer 110. Such metal oxo acids, in general, have a negative charge.

### Second Inorganic Material Layer 120

The second inorganic material layer 120 is a layer that includes, in an embodiment as a major component, an ionized form of an inorganic layered compound that can have a charge opposite to that of a charge of the first inorganic material layer 110. The inorganic layered compound of the second inorganic material layer 120 may include, for example, at least one selected from a clay mineral, a phosphate compound, i.e., a phosphate-based derivative, and layered double hydroxide compound.

The clay may be natural clay or a synthetic clay, and may be, for example, at least one selected from mica, bermiculite, montmorillonite, iron montmorillonite, beidellite, saponite, hectorite, stevensite, and nontronite. Also, the clay mineral may be an inorganic polymer compound having a layered structure, and for example, may have a crystal structure having silicate tetrahedron sheets alone, or alternating silicate tetrahedron sheets and octahedron sheets of aluminum oxide, magnesium oxide, or iron oxide octahedra. For example, montmorillonite, which is a layered compound, may be used. Montmorillonite is a smectite, and a 2:1 layered silicate in which one aluminate octahedron sheet is inserted between two silicate tetrahedron sheets. In an aluminate octahedron sheet, an Al³⁺ may be substituted with Mg²⁺, which has an ionic radius that is similar to that of Al³⁺, and in this case, the resulting mineral may have a similar crystal structure but a different chemical composition than that before the substitution. Due to the substitution, charge balance is broken and thus, a crystal main body is negatively charged. To compensate for this, an alkali metal or alkali earth-based metal is inserted on to a crystal surface or between crystal layers as a cation. Such particles (e.g., clay mineral particles) have a sheet-shape and are high aspect-ratio layered compound particles that include oxygen or silicon at their centers, and one to three tetrahedron layers or octahedron layers, each having a thickness of about 0.1 nm to about 10 nm, specifically about 0.5 nm to about 5 nm, and have a longer axis having a size of several tens of nanometers (e.g., 30 nm) to about 5 micrometers (μm), specifically about 40 nm to about 1 μm.

As a phosphate-based derivative, for example, α-zirconium phosphate may be used. In α-zirconium phosphate, a zirconium atom is disposed on a phosphate net to form a layered (e.g., sheet) structure. A phosphoric acid group is thus present above and under the zirconium, and a layered crystal main body is negatively charged, e.g., as in Zrₙ(PO₄)₂ₙ²⁻. Also, hydrogen ions, which are exchangeable with other ions, are located between the respective layers.

As a layered double hydroxide compound, for example, a compound represented by Formula 1 below may be used.

[M²⁺₁₋ₓM³⁺ₓ(OH)₂]^{x+}[Aⁿ⁻_{x/n}.yH₂O]^{x-} (Formula 1)

In Formula 1, M²⁺ is a bivalent metal, M³⁺ is a trivalent metal, Aⁿ⁻ is an anion, n is a valence the anion, x is a real number satisfying 0<x<0.4, and y is a real number greater than 0. That is, the layered double hydroxide compound is a layered (e.g., sheet-shaped) compound in which an intermediate layer is formed from an anion and an interlayer water and is negatively charged, that is, an interlayer ion ([Aⁿ⁻_{x/n}.yH₂O]^{x-}) is present between basic layers having a positively charged brucite structure of ([M²⁺₁₋ₓM³⁺ₓ(OH)₂]^{x+}).

A layered crystal main body (that is, a basic layer) is positively charged so that the whole crystal of the layered double hydroxide compound is maintained in an electrically neutral state. The bivalent metal may be at least one selected from Mg, Mn, Fe, Co, Ni, Cu, Zn, and the like, and a trivalent metal may be at least one selected from Al, Fe, Cr, Co, In, and the like. Also, the anion, can be at least one selected from OH⁻, F⁻, Cl⁻, NO₃⁻, SO₄²⁻, CO₃²⁻, Fe(CN)₆⁴⁻, CH₃COO⁻, V₁₀O₂₈⁶⁻, C₁₂H₂₅SO₄⁻, and the like.

### Thicknesses of the Respective Layers

A thickness of the first inorganic material layer 110 may vary according to a solution for forming the first inorganic material layer 110 and/or a coating method, and a thickness thereof after drying may be in a range of about 100 nm to about 20 μm, specifically about 0.2 μm to about 10 μm, more specifically about 0.5 μm to about 5 μm. If the post-drying thickness is 100 nm or more, due to an uneven structure of the surface of a layer disposed thereunder, formation of pinholes may be prevented and thus, a sufficient film quality may be obtained. Also, to prevent cracks, the post-drying thickness may be 20 μm or less. For example, a post-drying thickness of the first inorganic material layer 110 may be in a range of about 200 nm to about 10 μm, and for example, may be in a range of 500 nm to 5 μm.

A thickness of the second inorganic material layer 120 may vary according to a material for forming the second inorganic material layer 120, and may be in a range of about 0.1 nm to about 500 nm, specifically about 0.2 nm to about 300 nm, more specifically about 0.5 nm to about 100 nm. The second inorganic material layer 120 may be formed such that inorganic layered compounds are disposed without any gap therebetween. If the thickness of the second inorganic material layer 120 is 0.1 nm or more, the second inorganic material layer 120 may be disposed such that the inorganic layered compounds are disposed without any gap therebetween. Also, if the second inorganic material layer 120 is too thick, the gap between the layered compounds is increased, and a secondary aggregated product of the layered compounds may be formed. Thus, the thickness of the second inorganic material layer 120 may be about 500 nm or less. A thickness of the second inorganic material layer 120 may be in a range of about 0.5 nm to about 100 nm, for example, about 0.5 nm to about 50 nm. Also, the thickness of the second inorganic material layer 120 may be measured by using a stylus type surface profiler (for example, Dektak 150 stylus profilometer manufactured by Bruker).

### Arrangement of the Respective Layers

The arrangement of the first inorganic material layer 110 and the second inorganic material layer 120 may not be limited as long as the first inorganic material layer 110 and the second inorganic material layer 120 are alternately arranged. From among a plurality of layers included in the layered film, the innermost layer that contacts the resin film 101 and the outermost layer from the resin film 101 (e.g., the inorganic layer distal to the resin film 101) may all be the first inorganic material layer 110. That is, when n first inorganic material layers 110 are stacked, n−1 second inorganic material layers 120 are stacked so that in the layered film, the lowermost layer and the uppermost layer (that is, the outermost layer) may be the first inorganic material layer 110. An inorganic layered compound, such as clay mineral, may expand by absorbing water. Also, when the inorganic layered compound expands, a layer including the inorganic layered compound may be exfoliated from an adjacent layer. Accordingly, when the lowermost layer and the uppermost layer of the stack film are the first inorganic material layers 110, permeation of water into the layered film may be prevented and thus, the expansion of the inorganic layered compound may be suppressed or prevented.

### Analysis of Stacking of the Inorganic Layered Compound

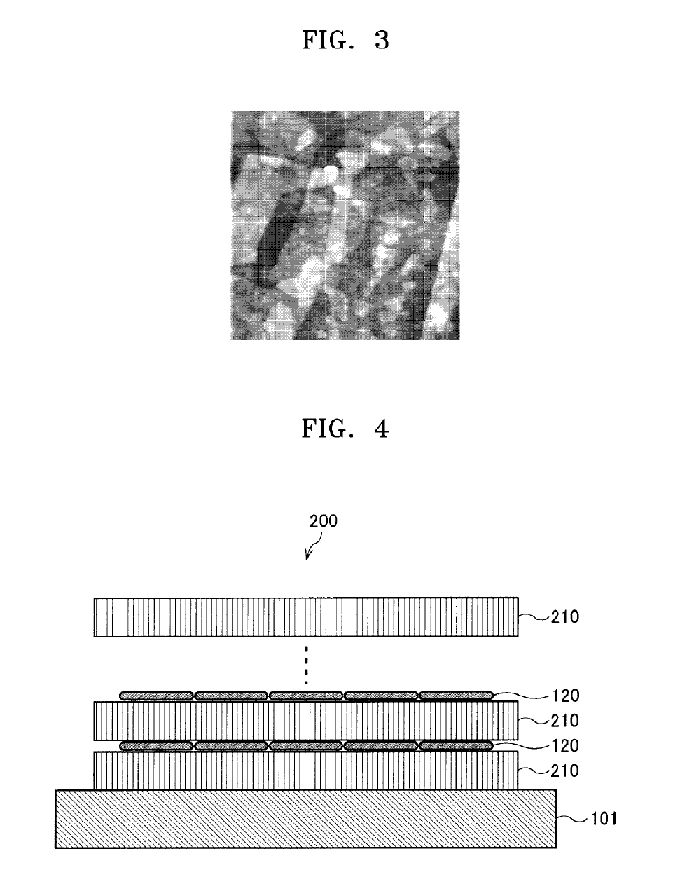

Herein, the stacking of the second inorganic material layer 120 on the first inorganic material layer 110 may be confirmed from, for example, an atomic force microscope (AFM) image of a substrate in which the layered film is included. As a reference, FIG. 3 shows an example of an AFM image from which the stacking of the second inorganic material layer 120 on the first inorganic material layer 110 is confirmed. Referring to FIG. 3, the polygonal structure is the second inorganic material layer 120, and thus and while not wanting to be bound by theory, because the polygonal structure is observed, it can be said that the second inorganic material layer 120 is stacked on the first inorganic material layer 110.

### Method of Forming the First Barrier Film 100

Hereinbefore, the structure of an embodiment of the first barrier film 100 has been described in further detail. Hereinafter, a method of forming the first barrier film 100 having the above-described structure is described in further detail below.

The first barrier film 100 may be formed by alternately disposing (e.g., stacking) one or more of the first inorganic material layer 110 and one or more of the second inorganic material layer 120 on the resin film 101. Such a layer structure may be obtained by repeatedly and sequentially performing a process of disposing (e.g., forming) the first inorganic material layer 110 on the resin film 101, a process of disposing (e.g., forming) the second inorganic material layer 120 on the first inorganic material layer 110, and a process of disposing (e.g., forming) the first inorganic material layer 110 on the second inorganic material layer 120.

### Process of Forming the First Inorganic Material Layer 110

A method of forming the first inorganic material layer 110 is not particularly limited, and hereinafter, an example of a method of forming the first inorganic material layer 110 having an onium salt structure is further described below. In a method of forming the first inorganic material layer 110 having an onium salt structure, for example, a selected amount of an onium salt compound is added to a sol-gel material that is used to form the first inorganic material layer 110. As an onium salt compound, a mono-molecular compound, such as an alkylammonium halide (e.g., a C1-C10 alkylammonium halide) or an arylammonium halide (e.g., a C6-C20 arylammonium halide), may be used, or as described below, a sol-gel material for forming the first inorganic material layer 110 and a sol-gel material having a substituent for forming an onium salt are used to include an onium salt formation site into the first inorganic material layer 110.

Regarding the method of including the onium salt formation site into the first inorganic material layer 110, as the sol-gel material and the sol-gel material having a substituent for forming an onium salt, a solution including at least one selected from an alkoxysilane, metal alkoxide, polysilazane, and an alkali silicate may be used. Herein, alkoxysilane may be represented by the formula Si(OR)ₙ or Si(OR¹)ₙR²₄₋ₙ (wherein R, R¹, R² are each independently hydrogen, an alkyl group, e.g., a C1-10 alkyl group, or a substituent that is capable of forming an onium ion, wherein the onium forming substituent may be at least one selected from —NR₂, —SR, —PR₂, and the like wherein each R is independently hydrogen or an alkyl group, e.g., a C1-10 alkyl group), and the metal alkoxide may be represented by M(OR)ₙ or M(OR¹)ₙR²ₓ₋ₙ (wherein R, R¹, R² are each independently hydrogen, an alkyl group, e.g., a C1-10 alkyl group or a substituent that is capable of forming an onium ion, wherein the onium ion forming substituent may be at least one selected from —NR₂, —SR, —PR₂, and the like wherein each R is each independently hydrogen or an alkyl group, e.g., a C1-10 alkyl group, M is at least one selected from Ti, Al, Zr, and the like, and x is a valence number of the metal). Also, the polysilazane may be converted into silicon oxide or silicon nitride by heating, and may be represented by the formula —(R¹R²—Si—NH)— (wherein R¹ and R² are each independently hydrogen, an alkyl group, or a substituent that is capable of forming an onium ion, wherein the onium forming substituent may be at least one selected from —NR₂, —SR, —PR₂, and the like wherein each R is independently hydrogen or an alkyl group, e.g., a C1-10 alkyl group). An alkali silicate may be represented by the formula M₂O.nSiO₂ (M is an alkali metal, and n is a molar ratio of about 1 to about 20). In the method of forming the first inorganic material layer 110, these compounds may be used alone or in combination to form a film of the first inorganic material layer 110.

This method is further described in detail below. For example, a silane coupling agent having an amino group, which is a kind of alkoxysilane, is mixed with a silane coupling agent, such as tetraethoxysilane (TEOS), which is a kind of alkoxysilane, and hydrolysis of the mixture is performed to synthesize a sol-gel material including an amino group, and then, the sol-gel material is coated on a substrate, followed by heating and calcining to form the first inorganic material layer 110 including an amino group. The sol-gel material including an amino group may be at least one selected from 3-aminopropyltrimethoxysilane, 3-aminopropyltriethoxysilane, N-phenyl-3-aminopropyltrimethoxysilane, and the like, for example, which are available from Sinetz Silicone Company or Tokyo Chemical Industry.

Hereinafter, an example of a chemical reaction scheme (Reaction Scheme 1) used in an embodiment of the method of forming the first inorganic material layer 110 is further described. For example, in Reaction Scheme 1 below, Cl⁻ (chloride ion) is ion-exchanged with a negative charge of an inorganic layered compound, and the inorganic layered compound is electrostatically adsorbed on to the first inorganic material layer 110 to form a stack structure of the first inorganic material layer 110 and the second inorganic material layer 120.

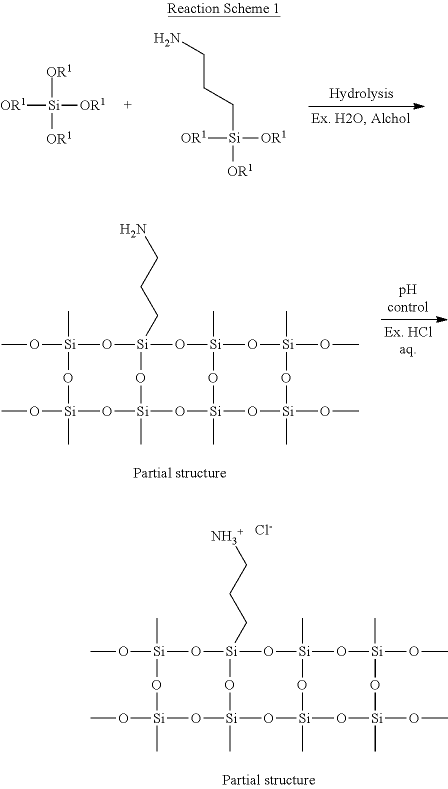

As another example of the method of forming the onium ion-containing first inorganic material layer 110, a sol-gel material (e.g., a silane coupling material) having a halogenated alkyl group or a halogenated acyl group is combined with TEOS or the like according the method described above, and hydrolysis of the combination is performed to form the first inorganic material layer 110 having a halogen group. Thereafter, the first inorganic material layer 110 having a halogen group is reacted with at least one selected from an alkyl amine, aryl amine, alkyl sulfide, aryl sulfide, alkyl phosphine, and an aryl phosphine to form an onium salt. These methods enable production of the first inorganic material layer 110 including an onium ion which is not commercially available.

As an example of the sol-gel material including a halogenated alkyl group or a halogenated acyl group, 3-chloropropyltrimethoxysilane, (chloromethyl) triethoxysilane, or 3-chloropropylmethoxymethylsilane, which are available from Sinetz Silicone Company or Tokyo Chemical industry, may be used.

An example of a chemical reaction scheme (Reaction Scheme 2 below) in which an exchange reaction is performed between the first inorganic material layer 110 including a halogenated alkyl group and an onium base is described.

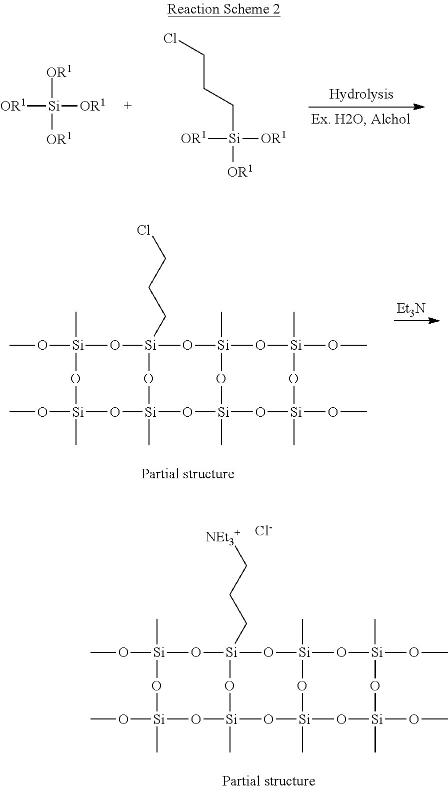

Herein, when the silane coupling agent is subjected to hydrolysis, an acid catalyst may be used to increase the reaction speed of hydrolysis. The acid catalyst may be a hydrochloric acid. Other examples of the acid catalyst include a sulfuric acid and an acetic acid.

Also, the solution for forming the first inorganic material layer 110 may include an alcohol, such as ethanol, as a solvent. An amount of the solvent may be controlled such that the solution for forming the first inorganic material layer 110 has an appropriate level of viscosity that is suitable for the coating on the resin film 101.

When the two kinds of alkoxysilane (e.g., an alkoxysilane that has a substituent that is capable of forming an onium salt and an alkoxysilane that does not have the substituent that is capable of forming an onium ion), water, and an acid catalyst, such as a hydrochloric acid, are combined with a solvent, partial hydrolysis of the alkoxysilanes occurs and thus a portion of a network is formed having the —O—Si—O— bond. In this regard, some alkoxysilanes remain unreacted, and a portion in which the —O—Si—O— bond is formed due to the hydrolysis and a portion in which the —O—Si—O— bond is not formed due to no reaction co-exist. That is, the partial structures shown in Reaction Scheme 1 and 2 may be formed and a reaction product including the partial structures may be present in a solution and dissolved in the solvent.

Also, when the alkoxysilane is used as a first inorganic material that is capable of forming the first inorganic material layer 110, the solution for forming the first inorganic material layer 110 may include the alkoxysilane that does not include a substituent that is capable of forming an onium salt (for example, tetramethoxysilane (TMOS)), the alkoxysilane that includes a substituent that is capable of forming an onium salt (for example, aminotripropylmethoxysilane (APTES)), water used for hydrolysis, an acid catalyst (for example, hydrochloric acid), and a solvent (for example, ethanol). A mixing ratio of these components is further described below.

A mixing ratio (e.g., a mass ratio) of the total amount of alkoxysilanes in the solution, that is, (an amount of the alkoxysilane that does not include a substituent that is capable of forming an onium salt+an amount of the alkoxysilane that includes a substituent that is capable of forming an onium salt)/(an amount of the alkoxysilane that does not include a substituent that is capable of forming an onium salt+an amount of the alkoxysilane that does not include a substituent that is capable of forming an onium salt+an amount of water+an amount of acid catalyst) may be in a range of about 0.01 to about 0.7, for example, about 0.05 to about 0.5, and for example, about 0.1 to about 0.4. If the mixing ratio is greater than about 0.7 or less than about 0.01, the polymerization reaction may not occur and the alkoxysilanes may turn into solid powder and thus, a film may not be formed.

Also, the mixing ratio (e.g., the mass ratio) of an amount of the alkoxysilane that does not include a substituent that is capable of forming an onium salt to an amount of the alkoxysilane that includes a substituent that forms an onium salt, that is, (an amount of the alkoxysilane that includes a substituent that is capable of forming an onium salt)/(an amount of the alkoxysilane that does not include a substituent that is capable of forming an onium salt+an amount of the alkoxysilane that includes a substituent that is capable of forming an onium salt) may be about 0.6 or less, for example, about 0.4 or less, for example, about 0.3 or less, specifically about 0.01 to about 0.6. If the relative amount of the alkoxysilane that includes a substituent that is capable of forming an onium salt is increased and the mixing ratio becomes higher than the foregoing range, the first inorganic material layer 110 may have a defect, that is, the first inorganic material layer 110 may include pores, and through the pores, water or oxygen may permeate and the barrier performance of the resulting film may be decreased.

Also, when the metal alkoxide, polysilazane, and alkali silicate are used as the first inorganic material of the first inorganic material layer 110, the same mixing ratio may be used.

Then, the solution for forming the first inorganic material layer 110 is disposed on (e.g., coated on) the resin film 101. The coating method is not particularly limited, and may be, for example, a method known to one of skill in the art and which can be determined without undue experimentation, such as, dipping, spin coating, roll coating, spraying, or the like.

Thereafter, the coated solution is heated and dried to form the first inorganic material layer 110. Due to the heating and drying, non-reacted alkoxysilanes are reacted to complete the formation of a network having the —O—Si—O bond. In this regard, the drying condition is not particularly limited as long as hydrolysis of the alkoxysilane is sufficiently performed. For example, the drying may be performed at a temperature of about 100° C. to about 400° C., specifically about 120° C. to about 380° C., more specifically about 140° C. to about 360° C. After the drying, the resin film 101 on which the first inorganic material layer 110 is formed is washed by immersion in, for example, pure water, and then, the water is evaporated therefrom by using, for example, an air blower.

### Process of Forming the Second Inorganic Material Layer 120

An inorganic layered compound having a charge opposite to that of the first inorganic material layer 110 is disposed on (e.g., attached to) the first inorganic material layer 110 by an electrostatic force to form the second inorganic material layer 120.

Herein, particles of an inorganic layered compound that is used in forming the second inorganic material layer 120 may be, in a particulate state, aggregated to form larger particles. Accordingly, for use in forming the second inorganic material layer 120, the aggregated particles are desirably exfoliated and dispersed in a liquid such as water. The aggregated particles may form a layered structure of tabular sheets. A counter ion (for example, a positively charged material, such as Na⁺ or an organic cation when the inorganic layered compound is a negatively charged compound, such as montmorillonite or zirconium phosphate) having a charge opposite to that of the inorganic layered compound is inserted between the respective layers and attached to the layers by an electrostatic force. When the aggregated state of the inorganic layered compound is dispersed in water, water molecules that are larger than the counter ion permeate between the respective layers. Thus, an interval (e.g., distance) between the respective layers are enlarged so that an interaction by the electrostatic force is decreased, thereby enabling exfoliation of the respective layers. As described above, and while not wanting to be bound by theory, an inorganic layered compound that is positively or negatively charged may be obtained by exfoliating the respective layers. Also, among the inorganic layered compounds, montmorillonite and zirconium phosphate may be used in consideration of the ease of exfoliation of the layers.

Then, the positively or negatively charged inorganic layered compound (e.g., a clay mineral, or the like) obtained as described above is dispersed in water or alcohol to prepare a solution for forming the second inorganic material layer 120, and this solution is disposed on (e.g., coated on) the first inorganic material layer 110 having a charge opposite to that of the inorganic layered compound (for example, the first inorganic material layer 110 having a substituent, such as an amino group, that is capable of forming an onium salt) to provide an ion exchange reaction between the inorganic layered compound and the charged site (i.e., an anionic group or a cationic group) of the first inorganic material layer 110, thereby attaching the inorganic layered compound to a surface of the first inorganic material layer 110 by an electrostatic force (e.g., a coulomb force).

For example, when a negatively charged material, such as a clay mineral, is used as an inorganic layered compound, and a positively chargeable material that has a substituent, such as an amino group, that is capable of forming an onium salt is used as a first inorganic material layer 110, an ion exchange reaction is performed between a counter cation, such as lithium or sodium of the inorganic layered compound and an onium salt (ammonium salt, or the like) to attach the inorganic layered compound, such as clay mineral, to a surface of the first inorganic material layer 110 by an electrostatic force. In this regard, the first inorganic material layer 110 including the amino group may be immersed in the solution for forming the second inorganic material layer 120 (a dispersion in which the clay mineral is dispersed in a solvent). Alternatively, the first inorganic material layer 110 including the amino group may be pre-treated with an aqueous solution of hydrochloric acid or an organic acid, or an alcohol solution to actively form an onium salt, followed by immersing in a dispersion of the clay mineral. Also, a pH of the dispersion of the clay mineral may be controlled with hydrochloric acid or an organic acid to promote the ion exchange reaction.

A coating method of the solution for forming the second inorganic material layer 120 is not particularly limited, and may include, for example, dipping, spin coating, roll coating, spraying, or the like. For example, in consideration of ease of handling, dipping may be employed. That is, the first inorganic material layer 110 having a charge opposite to that of the inorganic layered compound ion is immersed in the solution for forming the second inorganic material layer 120 to adsorb the inorganic layered compound ion on to the surface of the first inorganic material layer 110 by a coulomb force to form a thin film. This method may be term an adsorption method.

A concentration of an inorganic layered compound in a dispersion of the inorganic layered compound used in forming the second inorganic material layer 120 may be in a range of about 0.01 grams per liter (g/L) to about 10 g/L, and for example, about 0.1 g/L to about 1 g/L. If the concentration of the inorganic layered compound is too low, the adsorption of the inorganic layered compound particles to the resin film 101 or the first inorganic material layer 110 may be insufficient. Also, if the concentration of the inorganic layered compound is too high, the viscosity of the dispersion may be too high. The dispersion may include at least water and the inorganic layered compound. However, the dispersion may further include a dispersing agent for increasing the dispersion property of the inorganic layered compound particles or an intercalating agent for promoting the exfoliation of the inorganic layered compound particles.

Conventionally, a stack of an inorganic layered compound, such as clay, has been disclosed. However, when an inorganic layered compound, such as clay, has a small cation, such as a sodium ion, as a counter cation, a multi-layer structure in which the intervals between the respective layers are narrow is formed. Also, when the inorganic layered compound bonds to the onium cation that is a macro counter cation by an electrostatic force, it is possible that only one layer of the inorganic layered compound is selectively disposed (e.g., formed) with high coverage (e.g., entirely covering the adjacent layer) and this layered compound may be horizontally arranged. Accordingly, high gas barrier performance may be obtained.

### Method of Stacking Two or More Layers

When two or more first inorganic material layers 110 or two or more second inorganic material layers 120 are formed, the process of forming the first inorganic material layer 110 and the process of forming the second inorganic material layer 120 may be repeatedly performed. For example, when the first inorganic material layer 110 of a second layer is formed on a substrate (that is, the resin film 101) on which a first layer including one first inorganic material layer 110 and one second inorganic material layer 120 are formed, a solution for forming the first inorganic material layer 110 having a site (a cationic group or an anionic group) that is chargeable with a charge opposite to that of the second inorganic material layer 120 is prepared, and then, the solution is coated on the second inorganic material layer 120, followed by heating and drying, in the same manner as used to form the first layer. Even when the second inorganic material layer 120 of the second layer is stacked on the first layer, the same method as used to form the second inorganic material layer 120 of the first layer may be used to form the second inorganic material layer 120 of the second layer.

### Regarding the Stacking Sequence

In the above embodiment, the first inorganic material layer 110 is formed on the resin film 101 and then the second inorganic material layer 120 is disposed thereon. However, alternatively, the second inorganic material layer 120 may be first formed on the resin film 101 and then, the first inorganic material layer 110 may be disposed thereon. In this case, the surface of the resin film 101 may be positively or negatively charged. The charging may be performed after the resin film 101 is washed using a selected method. The charging may be a physical treatment, such as a corona treatment or an ultraviolet ozone (UV/O₃) treatment, an electron beam (EB) treatment, or a chemical treatment, such as a treatment using a liquid, such as a silane coupling agent. For example, when the resin surface is treated with a corona, the surface of the resin film 101 may be negatively charged. Also, when a silane coupling agent including an amino group is used, the surface of the resin film 101 may be positively charged. Also, to increase the charging effect, a thin film of, for example, silica (this film is also referred to as an ‘adsorption layer’) may be formed on the resin film 101, and then the charging may be performed thereon. In detail, a metal oxide, such as silica or alumina, may be formed. In general, such metal oxides have an —OH group at a surface thereof in air, and thus, when treated with corona or UV/O₃, the surface may be strongly and uniformly charged. When the surface is charged using the silane coupling agent, the silane coupling agent bonds to the OH group at the surface of the metal oxide, so that the surface is strongly and uniformly charged.

Also, the first inorganic material layer 110 and the second inorganic material layer 120 may be formed using the same method described above.

### Second Embodiment

Hereinafter, a second barrier film 200 for an electronic device, according to another second embodiment, is further described. The second barrier film 200 is different from the first barrier film 100 according to the first embodiment in the structure of a first inorganic material layer. Hereinafter, the structure and manufacturing method of the second barrier film 200 are described below based on the difference with the first barrier film 100 of the first embodiment.

### Structure of the Second Barrier Film 200

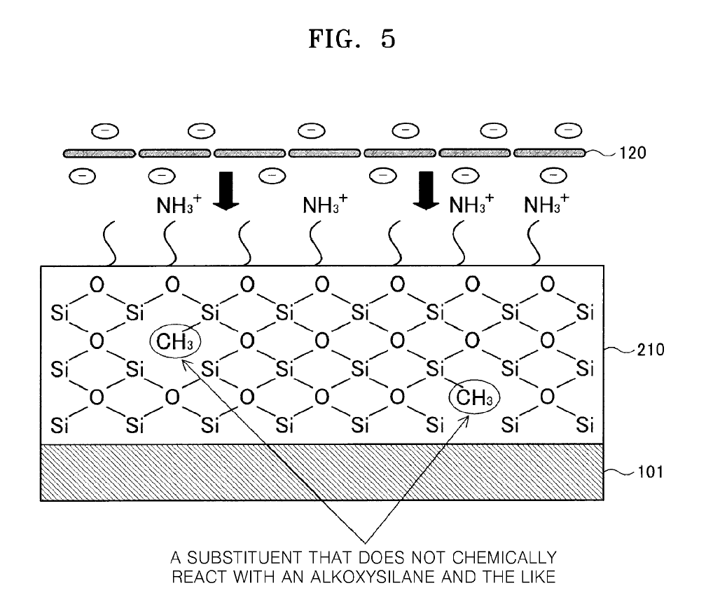

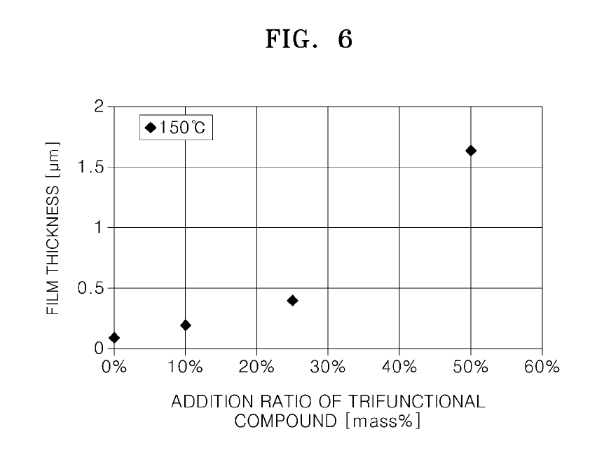

Referring to FIGS. 4 and 5, the structure of an embodiment of the second barrier film 200 is further described below. FIG. 4 is an explanatory diagram schematically illustrating an embodiment of the structure of the second barrier film 200 for an electronic device, and FIG. 5 is an explanatory diagram schematically illustrating an adhesion state between a first inorganic material layer 210 and the second inorganic material layer 120 illustrated in FIG. 4.

The second barrier film 200 as shown in FIGS. 4 and 5 is a substrate that can be used in a FPD or an illumination device, and includes the resin film 101, the third inorganic material layer 210 and the second inorganic material layer 120. For example, the second barrier film 200 is a substrate including a layered film including a plurality of layers formed on the resin film 101. Also, the layered film may be a film in which one or more of the third inorganic material layer 210 and one or more of the second inorganic material layer 120 are alternately stacked. That is, the layered film includes one or more of the third inorganic material layer 210 and one or more of the second inorganic material layer 120, and the third inorganic material layer 210 and the second inorganic material layer 120 are alternately stacked.

The third inorganic material layer 210 may be a layer formed by disposing (e.g., coating) a solution including, as a material for forming a framework thereof, at least one selected from an alkoxysilane, metal alkoxide, polysilazane, and alkali silicate on the resin film 101, followed by drying. Also, the solution for forming the third inorganic material layer 210, unlike the first inorganic material layer 110, may include as a material for forming a framework thereof, a compound that has a substituent that does not chemically react with at least one selected from an alkoxysilane, metal alkoxide, polysilazane, and an alkali silicate. In an embodiment the third inorganic material layer 210 includes a compound that has substituent that is substantially chemically inert to each of an alkoxysilane, metal alkoxide, polysilazane, and an alkali silicate. Such a substituent may not be limited, and may be, for example, a C₁₋₁₀ alkyl group (for example, methyl group), a phenyl group, or the like.

Herein, the structure of the first inorganic material layer 210 is described in further detail with reference to FIG. 5. FIG. 5 shows an embodiment in which the solution for forming the first inorganic material layer 210 includes an alkoxysilane represented by Si(OR¹)ₙR²₄₋ₙ (wherein R¹ is a C1-10 organic group, and R² is a substituent for forming an onium salt, such as —NR₂, —SR, and —PR₂) and an alkoxysilane represented by Si(OR³)ₙR⁴₄₋ₙ (wherein R³ is a C1-10 organic group, and R⁴ is a C1-10 alkyl group (in FIG. 5, a methyl group)). In this regard, R⁴ is an example of the substituent that does not chemically react with at least one selected from an alkoxysilane, metal alkoxide, polysilazane, and an alkali silicate. In this case, the solution including the alkoxysilane is coated on the resin film 101, followed by drying to form the third inorganic material layer 210. The third inorganic material layer 210 has the —O—Si—O— bond illustrated in FIG. 5 as a framework. The third inorganic material layer 210 includes the substituent (for example, a methyl group) that does not chemically react with the alkoxysilane, metal alkoxide, polysilazane, or alkali silicate, is effectively inserted into a portion of the framework. The third inorganic material layer 210 also has an ammonium group (e.g., an —NH₃⁺ group) as a site that is positively charged. FIG. 5 illustrates an embodiment in which the third inorganic material layer 210 is formed by a process comprising combining a silane coupling agent having an amino group, which is a kind of alkoxysilane, and a silane coupling agent, such as tetraethoxysilane (TEOS), which is a kind of alkoxysilane, methyltriethoxysilane (MeTEOS) to synthesize a first inorganic compound, and the first inorganic material is coated on a substrate, followed by heating and calcining to form the third inorganic material layer 210. Also, when the third inorganic material layer 210 is positively charged due to the structure of the ammonium salt that is formed, the second inorganic material layer 120 is formed using an inorganic layered compound (for example, montmorillonite) that can be ion exchanged to provide an anion.

As described above, the third inorganic material layer 210 and the second inorganic material layer 120 are oppositely charged so that the third inorganic material layer 210 is strongly attached to the second inorganic material layer 120 due to a coulombic force. Also, due to the inclusion of at least one selected from an alkoxysilane, metal alkoxide, polysilazane, and alkali silicate that include the chemically non-reactive substituent in the solution for forming the first inorganic material layer 210, so as to include the substituent that does not chemically react with alkoxysilane, metal alkoxide, polysilazane, and alkali silicate in a framework thereof, a flexibility of the third inorganic material layer 210 is increased and also a thickness thereof is increased. Therefore, a function of the third inorganic material layer 210 as a reinforcing layer may be enhanced.

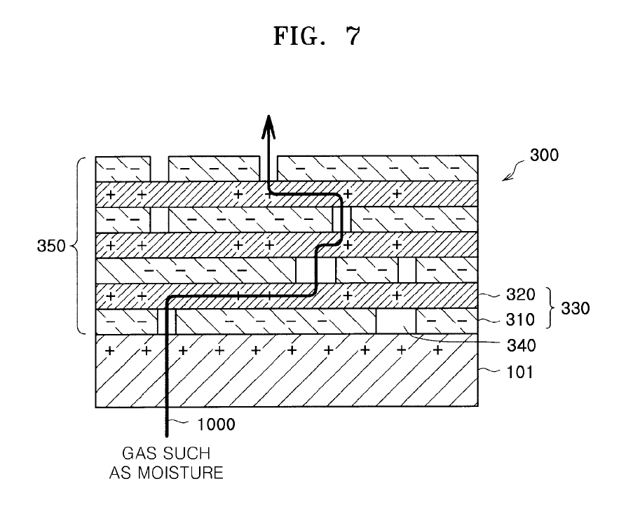

Herein, with reference to FIG. 6, the relationship between film thickness and an addition ratio of alkoxysilane, metal alkoxide, polysilazane, and alkali silicate that include the chemically non-reactive substituent (in FIG. 6, described as trifunctional functional compound addition ratio) is described. FIG. 6 shows an embodiment in which TEOS is used as the alkoxysilane, metal alkoxide, polysilazane, and alkali silicate, and MeTEOS is used as the alkoxysilane, metal alkoxide, polysilazane, and alkali silicate that includes the chemically non-reactive substituent. As shown in FIG. 6, when MeTEOS is added in an amount of 25 mass percent (mass %) with respect to TEOS, a film thickness was about 4 times greater than when METEOS is not added, and when MeTEOS is added in the same amount as that of TEOS, that is, in an amount of 50 mass %, a film thickness was about 15 greater than when MeTEOS is not added. However, if the amount of MeTEOS is too increased, the content of the chemically non-reactive substituent is increased, and thus, a formed film may have an unsuitable number of cavities (e.g., pores) and a gas barrier performance may be decreased. Accordingly, by comparing the flexibility and film thickness increasing effects with the decrease in the gas barrier performance, the addition amount may be controlled at an appropriate level.

### Method of Forming the Second Barrier Film 200

Hereinbefore, the structure of the second barrier film 200 has been described in detail. Hereinafter, a method of forming the second barrier film 200 having the above-described structure is described in further detail.

The manufacturing method of the second barrier film 200 is basically the same as the manufacturing method of the first barrier film 100, except that a solution for forming a first inorganic material layer includes at least one selected from the alkoxysilane, metal alkoxide, polysilazane, and alkali silicate, and at least one selected from the alkoxysilane, metal alkoxide, polysilazane, and alkali silicate which include a substituent that does not react with these compounds. As described above, due to the inclusion of at least one selected from alkoxysilane, metal alkoxide, polysilazane, and alkali silicate which include a substituent that does not react with these compounds, the flexibility and film thickness of a stack film may be increased.

As described above, regarding a barrier film for an electronic device, in a barrier film for an electronic device in which a layer having a gas barrier is formed on a film, a third inorganic material layer is attached to a layered compound having an opposite charge by an electrostatic force, so that a film that has high gas barrier performance and high reliability based on high interlayer adhesion is easily formed. Accordingly, the manufacturing cost of a barrier film for an electronic device may be reduced, and also, due to the formation on a film substrate (for example, the resin film 101) having flexibility, the barrier film may be used as a substrate for a display or an illumination device. Also, the use of a material having a substituent that does not chemically react with an alkoxysilane, metal alkoxide, polysilazane, and alkali silicate which are able to be used to form a framework of the first inorganic material layer may provide flexibility to the first inorganic material layer, and may enhance the function of the first inorganic material layer as a reinforcing layer.

Herein, the barrier film may be similar to a layered film of an inorganic thin film layer including clay and alkoxide disclosed in the references 1 and 2 in terms of a layer structure. However, the films are different in the layering technology. That is, in the barrier film for an electronic device disclosed herein, in which the respective layers are attached to each other by an electrostatic force, adhesion between the layers is high. This is distinguished from the technologies disclosed in references 1 and 2. Accordingly, a film with improved adhesion and high reliability may be obtained.

Also, although the reference 3 discloses that layers are attached to each other by an electrostatic force, an organic layer as disclosed in reference 3 does not have a barrier performance and heat resistance. In the disclosed barrier film, such defects are compensated for and thus, higher barrier performance may be obtained.

### Third Embodiment

Hereinafter, a third barrier film 300 for an electronic device is further described. The barrier film 300 is different from the first barrier film 100 according in the structure of a first inorganic material layer and a second inorganic material layer. Hereinafter, the structure and manufacturing method of the barrier film 300 are described below based on the difference with the first barrier film 100 of the first embodiment.

Hereinafter, a typical barrier film is described and then, the barrier film 300 according to the present embodiment is described in detail with reference to the attached drawings.

### Typical Barrier Film

As a flexible substrate for an electronic device, a barrier film in which a barrier layer is formed on a resin film is used. Typically, the barrier film is used to package food products. For the barrier film to be used in an electronic device, a substantial improvement in barrier performance would be desirable. For example, in the case of an organic electroluminescent device, which is an all solid-state light-emitting device known as being suitable for a flexible display, a barrier performance having a water vapor transmission rate (WVTR) of 1·10⁻⁶ g/m²/day would be desirable.

Various barrier films satisfying such high performance have been introduced by many companies. For example, US Vitex Corporation discloses a barrier film including a layer-by-layer stack structure of a resin film and an alumina layer. According to Vitex Corporation, the barrier film has high performance and is suitable for an organic light-emitting device. Also, a barrier film having a WVTR of 0.05 g/m²/day has been announced by Mitzbishi Resin Co., Ltd. on Feb. 20, 2008.

Following the introduction of these two technologies, many high-performance barrier films were formed by using a vacuum process. The vacuum process is, briefly, a process of attaching a barrier film forming material to a film substrate placed in a vacuum chamber. The vacuum process requires a big vacuum chamber and thus, installation costs are high. Also, the vacuum process has high operating costs for maintaining the vacuum chamber, and thus, the manufacturing cost of the barrier film prepared using the vacuum process are increased. Also, the vacuum process provides low step coverage on the barrier film, and thus, pin holes are likely to occur due to impurities on the film substrate.

Also, as a method of forming a barrier film, a film formation method using a wet process is known. This film formation method does not have the problems of the vacuum process, and thus, a barrier film may be formed with fewer pin holes and at lower costs. As a wet process, a sol-gel method or a method using clay particles that does not allow the gas permeation may be used. A method of forming a barrier film using these methods are disclosed in, in addition to the reference 5, JP 2007-22075 (herein referred to as reference 1), and JP 2003-41153 (herein referred to as reference 4). The technology and problems thereof disclosed in the reference 5 are already described above.

The reference 1 discloses a barrier film including a clay layer formed from clay particles (inorganic layered compound particles which are described below) and an inorganic layer formed by using a sol-gel method. According to the technology disclosed in the reference 1, the clay layer is formed by standing in an unagitated dispersion in which clay particles are dispersed. However, the clay layer formed as described above has a low adhesion force with other layers, that is, the inorganic layer. Also, because the clay layer is formed by only depositing clay particles, a bond between clay particles inside the clay layer is very weak. For example, once water permeates into the clay layer through the inorganic layer, water molecules may permeate into between clay particles and thus, the clay layer expands and thus, the barrier performance of the barrier film is substantially decreased. This may be prevented by lowering a WVPR of the inorganic layer. In this case, however, the inorganic layer is calcined at high temperature (about 100 to about 500° C.), which makes the manufacturing process complicated.

The reference 2 discloses a barrier film formed from a mixture of a sol-gel material and clay particles. In this technology, it is important to disperse clay particles in the sol-gel material with a high concentration thereof to increase barrier performances of a barrier film. An extent of increase in barrier performance of the barrier film when a layered compound, such as clay particles, is dispersed in the sol-gel material is exemplarily calculated in “Pnanocomposite=Barrier Enhancement: Tortuous Path,” L. E. Neilson, J. MACROMOL. SCI. (CHEM.), A1(5), 929-942 (1967). According to the calculation method of this literature, for example, when clay particles having a diameter of 1 μm and a thickness of 1 nm are used, to provide a two g/m²/day decrease in a WVTR, about 20 mass % of clay particles, based on the total mass of the barrier film, should be dispersed in the sol-gel material. A dispersion in which very planar particles, such as clay particles, are dispersed in the sol-gel material is thixotropic and thus, when standing, the dispersion may have a very high viscosity. Due to such a high viscosity, the dispersing of 20 mass % of clay particles in the sol-gel material is very difficult. Also, even when the clay particles are able to be dispersed in the sol-gel material with such a high concentration, due to such a high viscosity of the dispersion, it is difficult to coat the dispersion in a film shape.

The disclosed barrier film for an electronic device solves such problems. Hereinafter, the barrier film for an electronic device, according to the present embodiment, is described in detail.

### Structure of Barrier Film

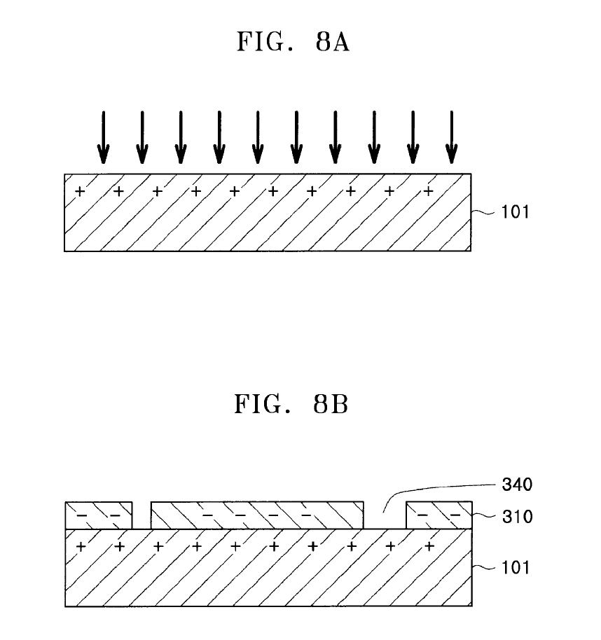

First, the structure of the barrier film 300 is described in further detail with reference to FIG. 7.

The third barrier film 300 includes the resin film 101, and a layer-by-layer stack portion 350 in which a fourth inorganic material layer 310 and a fifth inorganic material layer 320 are alternately stacked. Also, hereinafter, a film formed in the procedure of forming the barrier film 300, that is, a film in which at least one of the fourth inorganic material layer 310 and the fifth inorganic material layer 320 is stacked on the resin film 101 is referred to as at intermediate film.

### Structure of the Resin Film

The resin film 101 of the third barrier film 300 is the same as the resin film 101 of the first barrier film 100.

According to a charge of the resin film 101, the fourth inorganic material layer 310, and the fifth inorganic material layer 320 may be selected. For example, when the surface of the resin film 101 is positively charged and the fourth inorganic material layer 310 is negatively charged, the fourth inorganic material layer 310 is stacked on the resin film 101 and the fifth inorganic material layer 320 is stacked on the fourth inorganic material layer 310.

### Structure of the Fourth Inorganic Material Layer

Herein, the fourth inorganic material layer 310 of the third barrier film 300 is further described. The fourth inorganic material layer 310 includes tabular inorganic particles.

Tabular inorganic particles may be obtained by layer separation (e.g., exfoliation) of an inorganic layered compound, for example, a clay mineral, such as mica, bermiculite, montmorillonite, iron montmorillonite, beidellite, saponite, hectorite, and stevensite, zirconium phosphate, or a layered double hydroxide (LDH) compound.

In such inorganic layered compounds, a plurality of positively or negatively charged tabular inorganic particles may be stacked with an interlayer ion (for example, a sodium ion) having a charge opposite to that of the tabular inorganic particles and interposed therebetween. To exfoliate layers of the inorganic layered compound, for example, a species having a greater diameter than that of the interlayer ion may be inserted between the tabular inorganic particles. For example, a water molecule, a calcium ion, a tetrabutylammonium ion, or the like may be inserted between the tabular inorganic particles. For example, the inorganic layered compound may be added to water, followed by stirring.

The fourth inorganic material layer 310 may include a single type of tabular inorganic particle, or two or more different types of tabular inorganic particles having the same charge.

Also, ease of the layer separation may depend on the charge density of the inorganic layered compound. As an inorganic layered compound that is easily layer-separated, montmorillonite or zirconium phosphate may be used. Accordingly, such inorganic layered compounds are advantageous in terms of their ease of layer separation.

A tabular inorganic particle has a very planar shape, and may include an inorganic material, such as a metal oxide. The tabular inorganic particle may not allow gas to be permeated therethrough. Accordingly, by arranging the tabular inorganic particle to be parallel to other layers, the barrier performance of the third barrier film 300 may be improved.

The tabular inorganic particle may have, for example, a surface direction diameter of about 10 nanometers (nm) to about 10 μm, specifically about 50 nm to about 5 μm, and a thickness of about 1 to about 100 nm, specifically about 5 to about 50 nm, wherein a direction the thickness is perpendicular to the surface. Also, the surface direction diameter is, for example, an arithmetic mean of an average diameter of particles, and the thickness is an arithmetic mean of the thickness of the particles. The surface direction diameter and thickness of the tabular inorganic particle may be measured by, for example, a scanning electron microscope (SEM), atomic force microscope (AFM), or a laser scattering particle size distribution analyzer.

Also, the tabular inorganic particle may be, as described above, positively or negatively charged. For example, a tabular inorganic particle obtained from a clay mineral, such as mica, bermiculite, montmorillonite, iron montmorillonite, beidellite, saponite, hectorite, and stevensite, or zirconium phosphate may be negatively charged.

Also, a tabular inorganic particle obtained from the layered double hydroxide compound may be positively charged. That is, the layered double hydroxide compound may be represented by Formula 1 which has been described above in conjunction with the first barrier film 100.

Herein, the layered double hydroxide compound is an inorganic layered compound in which an interlayer ion (e.g., [Bⁿ⁻_{x/n}.yH₂O]^{x-}) that is formed from an anion and interlayer water and negatively charged is formed between layers of the positively charged tabular inorganic particle (e.g., [M²⁺₁₋ₓM³⁺ₓ(OH)₂]^{x+}).

The fourth inorganic material layer 310 may be formed by an adsorption method. The adsorption method comprises immersing of a substrate having a charged surface in a dispersion of oppositely charged particles. According to this method, particles are adsorbed to the substrate surface by a coulombic force. In the present embodiment, the resin film 101, or an intermediate film having a surface that is the fifth inorganic material layer 320, is immersed in a dispersion of a tabular inorganic particle charged with a charge opposite to the surface charge of the resin film 101 or the intermediate film. Thus, the tabular inorganic particle is adsorbed on to the surface of the resin film 101 or the intermediate film. In this regard, the tabular inorganic particle is adsorbed to be parallel to the surface of the resin film 101 or the intermediate film.

The dispersion of the tabular inorganic particle may be formed by combining an inorganic layered compound and water, followed by stirring. In this regard, a concentration of the inorganic layered compound may be in a range of about 0.01 to about 10 g/L, for example, about 0.1 to about 1 g/L. If the concentration of the inorganic layered compound is too low, the adsorption of the tabular inorganic particle onto the resin film 101 or the intermediate film may be insufficient. Also, if the concentration of the inorganic layered compound is too high, the viscosity of the dispersion may be too high. Although the dispersion is formed from at least water and the inorganic layered compound (in detail, tabular inorganic particles and interlayer ions formed by layer separation of the inorganic layered compound), the dispersion may further include a dispersing agent for increasing the dispersion properties of the tabular inorganic particle, or an intercalating agent for promoting the layer separation of the inorganic layered compound.

### Structure of Fifth Inorganic Material Layer

The fifth inorganic material layer 320 may include a binder particle (that is, a second inorganic material) that has a charge opposite to that of the fourth inorganic material layer 310. The binder particle may be, for example, at least one selected from a metal ion, a metal compound ion, and a tabular inorganic particle.

A metal ion may be an ion of at least one selected from aluminum, magnesium, potassium, and a polyvalent transition metal. The polyvalent transition metal may be iron, cobalt, or managanese. A metal compound ion may be an oxoacid ion of metal, for example, at least one selected from VO₃⁻, MoO₄²⁻, WO₄²⁻, and TiO²⁺. A tabular inorganic particle may be obtained by layer separation of the inorganic layered compound. That is, when the fourth inorganic material layer 310 includes a tabular inorganic particle that may be obtained from a clay mineral, the fifth inorganic material layer 320 may include a tabular inorganic particle that may be obtained from a layered double hydroxide compound. Alternatively, when the fourth inorganic material layer 310 includes a tabular inorganic particle that may be obtained from a layered double hydroxide compound, the fifth inorganic material layer 320 may include a tabular inorganic particle that may be obtained from a clay mineral.

The fifth inorganic material layer 320, like the fourth inorganic material layer 310, may be formed by an adsorption method. Regarding the third barrier film 300, the resin film 101, or an intermediate film having a surface that is the fourth inorganic material layer 310 is immersed in an aqueous solution (or dispersion) of an inorganic material having an opposite charge to that of the surface charge of the resin film 101 or the intermediate film. By doing so, the inorganic material is adsorbed to the surface of the resin film 101 or the intermediate film. That is, the fifth inorganic material layer 320 is formed on a surface of the resin film 101 or the intermediate film. In this regard, when the inorganic material includes a tabular inorganic particle, the tabular inorganic particle is adsorbed in parallel to the surface of the resin film 101 or the intermediate film.

A binder particle aqueous solution (or dispersion) may be obtained by dissolving or dispersing a water-soluble compound or the above-described inorganic layered compound in water. Herein, a concentration of the water-soluble compound or inorganic layered compound may be in a range of about 0.1 milligrams per liter (mg/L) to about 1 g/L, for example, about 1 mg/L to about 10 mg/L. If the concentration is too low, the adsorption of the binder particle to the resin film 101 or intermediate film may be insufficient. Also, if the concentration is too high, the binder particle aqueous solution (or dispersion) may have too high a viscosity. Although the binder particle aqueous solution (or dispersion) includes at least water and the binder particle, when the binder particle includes a tabular inorganic particle, a dispersing agent for increasing the dispersion properties of the tabular inorganic particle or an intercalating agent for promoting layer separation of the inorganic layered compound may be further included.

Also, when the fifth inorganic material layer 320 includes a metal ion, a water-soluble compound may be at least one selected from a sulfate, chloride, and a hydroxide of metal, and for example may be at least one selected from AlK(SO₄)₂, AlNH₄(SO₄)₂, MgCl₂, Mg(NO₃)₂, KOH, K₂SO₄, KCl, FeK(SO₄)₂, CoCl₂, Co(NO₃)₂, MnCl₂, Mn(NO₃)₂, NiCl₂, Ni(NO₃)₂, CuCl₂, Cu(NO₃)₂, ZnCl₂, Zn(NO₃)₂, and the like. When the fifth inorganic material layer 320 includes a metal compound ion, a water-soluble compound may be a sodium salt or an ammonium salt of an oxoacid, for example, at least one selected from NaVO₃, (NH₄)₂MoO₄, (NH₄)₂WO₄, TiOSO₄, and the like.

### Formation Method of Barrier Film

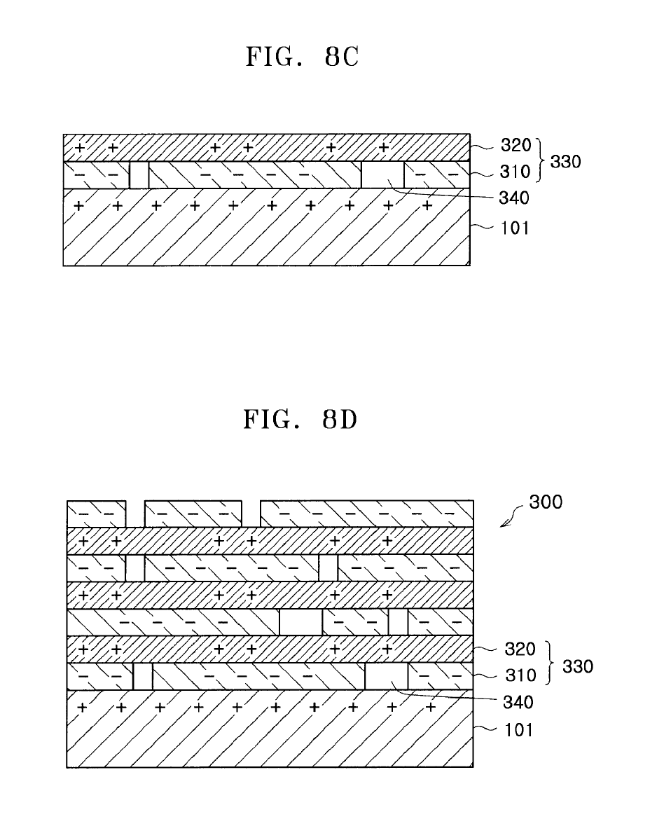

Next, a method of forming the third barrier film 300 is further described with reference to FIGS. 8A-8D. Herein, as an example of the formation method, the fourth inorganic material layer 310 is disposed on (e.g., stacked on) the resin film 101, and then the fifth inorganic material layer 320 is disposed on (e.g., stacked on) the fourth inorganic material layer 310. Alternatively, however, the fifth inorganic material layer 320 may be directly disposed on the resin film 101.

### First Step: Charging of the Resin Film 101

First, as shown in FIG. 8A, the surface of the resin film 101 is positively charged. Alternatively, an adsorption layer is formed on the resin film 101, and then the adsorption layer is positively charged. The charging method of the resin film 101 or the adsorption layer may be, for example, a corona treatment, an ultraviolet (UV)/O₃ treatment, an electron beam (EB) treatment, or a chemical treatment using, for example, a silane coupling agent.

### Second Step: Formation of the Fourth Inorganic Material Layer

As shown in FIG. 8B, the fourth inorganic material layer 310 that is negatively charged is formed on the resin film 101. In detail, first, at least one of the clay mineral and zirconium phosphate is added to water, followed by stirring to prepare a dispersion of a tabular inorganic particle. Also, the clay mineral and zirconium phosphate has a layered structure in which negatively charged tabular inorganic particles are stacked with an interlayer ion therebetween. Then, the resin film 101 is immersed in the dispersion of a tabular inorganic particle. By doing so, the tabular inorganic particle is adsorbed to the surface of the resin film 101. That is, the fourth inorganic material layer 310 is disposed on the resin film 101. The fourth inorganic material layer 310 may also include a defect 340 which lacks the tabular inorganic particle.

### Third Step: Formation of the Fifth Inorganic Material Layer

Then, as shown in FIG. 8C, the fifth inorganic material layer 320 is disposed on the first inorganic material layer 310. In detail, first, a binder particle aqueous solution (or a dispersion) in which at least one selected from a positively charged metal ion, a positively charged metal compound ion, and a positively charged tabular inorganic particle is dissolved (or dispersed) is prepared. Then, an intermediate film having a surface that is the fourth inorganic material layer 310 is immersed in the binder particle aqueous solution (or dispersion). By doing so, the binder particle is adsorbed to a surface of the intermediate film. That is, the fifth inorganic material layer 320 is disposed on a surface of the intermediate film. When the binder particle includes a tabular inorganic particle, the tabular inorganic particle is adsorbed in parallel to the surface of the intermediate film.

### Fourth Step: Repetition

Then, as shown in FIG. 8D, the second and third steps are repeatedly performed to alternately stack the fourth inorganic material layer 310 and the fifth inorganic material layer 320 on the resin film 101. A pair of the fourth inorganic material layer 310 and the fifth inorganic material layer 320 constitutes one unit 330, thereby completing the formation of the third barrier film 300.

### Operation of the Barrier Film

Then, referring to FIG. 7, operation of the third barrier film 300 is described in further detail. Once a gas, such as water vapor or oxygen gas, arrives at the fourth inorganic material layer 310 and passes through the resin film 101, the permeated gas may not pass through the tabular inorganic particle included in the fourth inorganic material layer 310. Accordingly, the gas may diffuse through a permeation pathway 1000 illustrated in FIG. 7. Gas permeation of the fourth barrier film 300 is proportional to, as shown in Equation (1) below, a length of the permeation pathway 1000, a permeation rate of the entire fifth inorganic material layer 320, and an area of a permeation cross section (a cross section perpendicular to the permeation pathway 1000) of the second inorganic material layer 320.

T∝L*Tb*Db (Equation 1)

### In Equation 1,

T is a gas permeation rate of the entire third barrier film 300;

L is a length of the permeation pathway in the fifth inorganic material layer 320;

Tb is a gas permeation rate of the entire fifth inorganic material layer 320; and

Db is a thickness of the fifth inorganic material layer 320 (for example, an arithmetic mean of the thicknesses of the respective fifth inorganic material layers 320. The thicknesses are measured by, for example, ellipsometer, AFM, or the like.

According to the technology disclosed in the reference 5, the second inorganic material layer is formed of a resin. Thus, Tb of Equation (1) has a very high value. However, because the fifth inorganic material layer 320 of the third barrier film 300 is comprises a second inorganic material, Tb has a very small value. For example, in the case of polyvinylidene chloride (PVDC), which is known as a resin having a very low gas permeation rate, when a film thickness is about 3 μm, a WVTR is about 4 g/m²/day. However, in the case of aluminum, when a film thickness is about 100 nm, a WVTR is about 1 g/m²/day. If these materials are compared at the same film thickness, the WVTR of Al is two or more-g/m²/day smaller than the resin. Accordingly, the third barrier film 300 may further decrease the gas permeation rate (that is, improve barrier performance) compared to the technology disclosed in the reference 5. Also, the third barrier film 300 includes a considerably smaller layer-by-layer adsorption number (number of units 330) than in a conventional case, which leads to simplification of the manufacturing process.

Also, the fifth inorganic material layer 320 of the third barrier film 300 may be formed by the adsorption method. Accordingly, compared to the technology disclosed in the reference 2, Db is very small. For example, Example 2 of the reference 2 discloses that 10 mass % of an inorganic layered compound formed from expandable synthetic mica is dispersed in a 3 μm sol-gel material. It is assumed that in Example 2 of the reference 4, an arithmetic mean interval between the inorganic layered compounds is about 300 nm. However, regarding the third barrier film 300, a film thickness of the fifth inorganic material layer 320 is 1 nm or less, and thus, Db is two or more-g/m²/day smaller than that of the corresponding layer of the reference 2. Also, when the fifth inorganic material layer 320 includes the inorganic layered compound disclosed in the reference 2, Tb is at the equivalent level. Accordingly, the third barrier film 300 has higher barrier performance than when the technology disclosed in the reference 2 is used.

Also, in the third barrier film 300, instead of using a water-susceptible (that is, expandable due to water) inorganic layered compound for the formation of the fourth inorganic material layer 310, an inorganic layered compound is layer-separated to form tabular inorganic particles, and these tabular inorganic particles are used to form the fourth inorganic material layer 310. In detail, in the third barrier film 300, an inorganic layered compound is contacted with water, followed by stirring to conduct layer separation of the inorganic layered compound. The resulting tabular inorganic particles are adsorbed on to the resin film 101 or the fifth inorganic material layer 320 by the ion adsorption method to form the fourth inorganic material layer 310. By doing so, in the third barrier film 300, expansion of the fourth inorganic material layer 310 due to the permeation of gas, such as water vapor, into the fourth inorganic material layer 310 may be substantially or effectively prevented. Also, in the third barrier film 300, because the tabular inorganic particle is adsorbed to other layers by a coulombic force, the permeation of gas, such as water vapor, between the fourth inorganic material layer 310 and other layers may be substantially or effectively prevented. Accordingly, the third barrier film 300 has higher barrier performance than when the technology disclosed in reference 1 is used.

Hereinafter, the disclosed embodiments are further described with reference to Examples. However, the present disclosure is not limited to the Examples.

### EXAMPLES

### Example 1

First, a substrate corresponding to a barrier film for an electronic device, according to barrier film 100, was formed by processes 1-1) to 1-5) below.

1-1) 6 grams (g) of tetramethoxysilane, 2 g of 3-aminopropyltrimethoxysilane, 2.5 g of water, 0.01 g of hydrochloric acid, and 9.5 g of ethanol were loaded into a glass vessel, followed by stirring for one day and night to obtain a solution for forming an inorganic material layer.

1-2) The solution obtained from 1-1) was coated on a PEN (Teijin Dupont product) substrate by using a spin coater and dried at a temperature of 150° C.

1-3) The substrate obtained from 1-2) was washed with ethanol and water and then water was evaporated by using an air blower.

1-4) 1 g of clay (natural montmorillonite) and 100 g of ultrapure water were loaded into a disposable plastic vessel, followed by 10 minutes of stirring to disperse clay, thereby preparing a solution for forming a layered compound.

1-5) The substrate obtained from 1-3) was immersed in the solution obtained from 1-4) for 30 minutes, and then the substrate was washed with water and dried by using an air blower.

1-6) The processes 1-2) to 1-5) were repeatedly performed to stack the respective layers.

Finally, four inorganic material layers and three layered compound layers were alternately disposed on one another to form a layered film. A thickness of each of the inorganic material layers was 0.2 μm, and a thickness of each of the layered compound layers was 0.001 μm.

The WVTRs of a barrier film for an electronic device including the layered film prepared as described above was measured with respect to water vapor (PERMATRAN-W (registered trademark) 3/33 series) and oxygen (OX-TRAN (registered trademark) 2/21 series) by using a WVPR measurement device (AQUATRAN, which is a product of MOCON). As a result, the permeation of water vapor and oxygen was not detected (that is the gas permeation rate is less than 0.02 g/cm²/24 h). From the results, it was confirmed that the layered film of Example 1 has a very high gas barrier performance. Also, to confirm an adhesion force of the layered film, a peeling test was performed thereon using Scotch® tape. As a result, the exfoliation of the respective layers of the stack film did not occur. Also, as an environmental test of the stack film, a heat resistance test was performed thereon. However, up to a heat resistance temperature of the PEN substrate, that is, 180° C., the layered film was neither deformed nor exfoliated.

### Example 2

A substrate corresponding to a barrier film for an electronic device, according to the second barrier film 200, was formed by using processes 2-1 to 2-5).

2-1) 5 g of tetramethoxysilane, 1 g of methyltriethoxysilane, 2 g of 3-aminopropyltrimethoxysilane, 2.5 g of water, 0.01 g of hydrochloric acid, and 9.5 g of ethanol were loaded into a glass vessel, followed by stirring for one day and night to obtain a solution for forming an inorganic material layer.

2-2) The solution obtained from 2-1) was coated on a PEN (Teijin Dupont product) substrate by using a spin coater and dried at a temperature of 150° C.

2-3) The substrate obtained from 2-2) was washed with ethanol and water and then water was evaporated by using an air blower.

2-4) 1 g of clay (natural montmorillonite) and 100 g of ultrapure water was added to a disposable plastic vessel and stirred for 10 minutes to disperse the clay, thereby obtaining a solution for forming a layered compound.

2-5) The substrate obtained from 2-3) was immersed in the solution obtained from 2-4) for 30 minutes, and then the substrate was washed with water and dried by using an air blower.

2-6) The processes 2-2) to 2-5) were repeatedly performed to stack the respective layers.

Finally, four inorganic material layers and three layered compound layers were alternately disposed on one another to form a layered film. A thickness of each of the inorganic material layers was 0.3 μm, and a thickness of each of the layered compound layers was 0.001 μm.

The WVTRs of a barrier film for an electronic device including the layered film prepared described above was measured with respect to water vapor (PERMATRAN-W® 3/33 series) and oxygen (OX-TRAN (registered trademark) 2/21 series) using a WVPR measurement device (AQUATRAN, which is a product of MOCON). As a result, the permeation of water vapor and oxygen was not detected (that is the gas permeation rate is less than 0.02 g/cm²/24 h). From the results, it was confirmed that the layered film of Example 2 has a very high gas barrier performance. Also, to confirm an adhesion force of the layered film, a peeling test was performed thereon using Scotch® tape. As a result, the exfoliation of the respective layers of the layered film did not occur. Also, as an environmental test of the layered film, a heat resistance test was performed thereon. However, up to a heat resistance temperature of the PEN substrate, that is, 180° C., the layered film was neither deformed nor exfoliated. Also, regarding the thickness of the layered film, it was confirmed that the flexibility of the layered film is enhanced because the film thickness of the present example is greater than that of Example 1.

### Comparative Example 1

A substrate corresponding to a substrate disclosed in reference 1 was formed using processes 3-1 to 3-5).

3-1) 1 g of clay (natural montmorillonite) and 49 g of ultrapure water were stirred for 15 minutes to disperse the clay to prepare a dispersion) for forming a layered compound layer.

3-2) The clay dispersion obtained from 3-1) was left for one day and night, and then, spread on a PEN film laid on a disposable tray, and slowly dried at a temperature of 50° C. for about one day to form a clay thin film layer.

3-3) Polysilazane was coated on the clay thin film layer formed from 3-2) by using a spin coater.

3-4) The clay thin film layer on which polysilazane was coated was located on a hot plate at a temperature of 150° C., and then heated for about 10 minutes to evaporate a solvent, thereby drying the polysilazane coating surface.

3-5) The substrate obtained from 3-4) was calcined under an atmospheric condition at a temperature of 250° C. for 1 hour.

3-6) The processes 3-2) to 3-5) were repeatedly performed to stack the respective layers.

Finally, four inorganic material layers and three layered compound layers were alternately disposed on one another to form a layered film. A thickness of each of the inorganic material layers was 0.2 μm, and a thickness of each of the layered compound layers was 0.001 μm.

The WVTR of a substrate including a layered film prepared as described above was measured with respect to water vapor (PERMATRAN-W® 3/33 series) and oxygen (OX-TRAN (registered trademark) 2/21 series) by using a WVPR measurement device (AQUATRAN, which is a product of MOCON). As a result, the permeation of water vapor was not detected (that is the gas permeation rate is less than 0.02 g/cm²/24 h), and the permeation of a small amount of oxygen was detected (0.1 g/cm²/24 h). From the results, it was confirmed that the layered film of Comparative Example 1 has a lower gas barrier performance than those of Examples 1 and 2. Also, to confirm an adhesion force of the layered film, a peeling test was performed thereon using Scotch® tape. As a result, the respective layers of the stack film were easily peeled off and thus it was confirmed that the interlayer adhesion is low. Also, as an environmental test of the layered film, a heat resistance test was performed thereon. However, up to a heat resistance temperature of the PEN substrate, that is, 180° C., the layered film was neither deformed nor exfoliated.

### Comparative Example 2

A substrate corresponding to a substrate disclosed in the reference 3 was formed by using processes 4-1 to 4-5).

4-1) 50 g of acryl monomer, 2 g of acryloxyethyltrimethylammonium chloride, and 300 g of pure water were mixed, followed by 1 hour of stirring at room temperature.

4-2) 0.05 g of ammonium sulfate, 0.05 g of sodium sulfite, and 20 g of pure water were added to the solution obtained from 4-1), followed by stirring at a temperature of 50° C. for 2 hours. Also, 0.05 g of ammonium sulfate, 0.05 g of sodium sulfite, and 20 g of pure water were added thereto and stirred while naturally cooling at room temperature.

4-3) 0.5 g of montmorillonite was added to 1 L of pure water and stirred for 24 hours.

4-4) A PEN film was immersed in the solution obtained from 4-2) for 10 minutes, and then sufficiently washed with pure water.

4-5) The film obtained from 4-4) was immersed in the solution obtained from 4-3), and then sufficiently washed with pure water, and then dried using an air blower, thereby obtaining a substrate on which a layered compound layer was formed.

4-6) The processes 4-4) to 4-5) were repeatedly performed to stack the respective layers.

That is, in Comparative Example 2, one layered compound layer was stacked (Comparative Example 2-1) and 10 layered compound layers were stacked (Comparative Example 2-2). A thickness of each of the layered compound layers was 0.001 μm.

The WVTR of a substrate including a film prepared as described above was measured with respect to water vapor (PERMATRAN-W (registered trademark) 3/33 series) and oxygen (OX-TRAN (registered trademark) 2/21 series) by using a WVPR measurement device (AQUATRAN, which is a product of MOCON). As a result, the permeation of oxygen was not detected (that is the gas permeation rate is less than 0.02 g/cm²/24 h), and the permeation of a great amount of water vapor was detected (27 g/cm²·24 h in the case of Comparative Example 2-1, and 5.8 g/cm²·24 h in the case of Comparative Example 2-2). From the results, it was confirmed that the layered film of Comparative Example 2 has a lower gas barrier performance than those of Examples 1 and 2. Also, to confirm an adhesion force of the layered film, a peeling test was performed thereon using Scotch® tape. As a result, exfoliation of the respective layer did not occur. Also, as an environmental test of the layered film, a heat resistance test was performed thereon. However, at a temperature of about 100° C., the film was deformed or exfoliated. Thus, it was confirmed that the film had low heat resistance.

The stack number, film thickness, gas permeation rate, exfoliation test results, and heat resistance test results of the respective layers of Example 1, Example 2, Comparative Example 1, Comparative Example 2-1, and Comparative Example 2-2 are shown in Table 1 below.

TABLE 1
Characteristics of the Examples and Comparative Examples

| | Inorganic | Layered | | | | | |
|---|---|---|---|---|---|---|---|
| | material | compound | | | | | |
| | layer (e.g., | layer | | | | | |
| | first inorganic | (e.g., second | Film | WVTR(g/cm²/24 h) | | | Heat |
| | material | inorganic | thickness | Water | | | resistance |
| | layer) | material layer) | (μm) | vapor | Oxygen | Peeling test | test |
| Example 1 | Four layers | Three layers | 1.4 | <0.02 | <0.02 | No peeling | > |
| | | | | | | | Heat resistance |
| | | | | | | | temperature |
| | | | | | | | than |
| | | | | | | | PEN |
| Example 2 | Four layers | Three layers | 3.1 | <0.02 | <0.02 | No peeling | > |
| | | | | | | | Heat resistance |
| | | | | | | | temperature |
| | | | | | | | than |
| | | | | | | | PEN |
| Comparative | Four layers | Three layers | 3.3 | <0.02 | 0.1 | Peeling | > |
| Example 1 | | | | | | occurred | Heat resistance |
| | | | | | | | temperature |
| | | | | | | | than |
| | | | | | | | PEN |
| Comparative | — | One layer | 0.001 | 27 | <0.02 | No peeling | <100° C. |
| Example 2-1 | | | | | | | |
| Comparative | — | Ten layers | 0.01 | 5.8 | <0.02 | No peeling | <100° C. |
| Example 2-2 | | | | | | | |

### Example 3

A substrate corresponding to a barrier film for an electronic device, according to the third barrier film 300, was formed by the following processes. In the present experiment, the resin film 101 was negatively charged, and the positively charged fifth inorganic material layer 320 and the negatively fourth first inorganic material layer 310 were alternately stacked on the resin film 101.

### 1) Washing of Resin Film 101

A PET film having a thickness of 0.1 mm was prepared as the resin film 101. The resin film 101 was washed with a detergent and pure water and dried by using an air blower.

### 2) Preparation of Tabular Inorganic Particle Dispersion

0.5 g of Kunipil-D36, which is a product of Kuminine industry and is a montmorillonite (MMT), was added to 1 L of pure water, and stirred by using a commercially available agitator (KNS-T1, a product of Azwon) for one day. By doing so, a tabular inorganic particle dispersion in which a tabular inorganic particle was dispersed was prepared

### 3) Preparation of Binder Particle Aqueous Solution

Aqueous solution having 30 mmol/L of AlK(SO₄)₂ was prepared.

### 4) Charging of the Resin Film 101

The resin film 101 washed in the process 1) was subjected to a corona treatment by using HPS-101, which is a product of Japanese STATIC Company, for 10 minutes. By doing so, the resin film 101 was negatively charged.

### 5) Formation of Fifth Inorganic Material Layer

The resin film 101 charged in the process 4) was immersed in the binder particle dispersion prepared in the process 3) for 15 minutes, and then sufficiently washed with pure water, and dried by using an air blower. By doing so, the fifth inorganic material layer 320 was formed on the resin film 101.

### 6) Formation of First Inorganic Material Layer

The resin film 101 on which the fifth inorganic material layer 320 was formed, prepared from the process 5) was immersed in the tabular inorganic particle dispersion prepared from the process 2) for 15 minutes, and then sufficiently washed with pure water, and dried by using an air blower. By doing so, the fourth inorganic material layer 310 was formed on the fifth inorganic material layer 320.

### 7) Layer-by-Layer Adsorption

The processes 5) and 6) were repeatedly performed 5, 10, and 20 times to form three third barrier films 300 in which 5, 10, and 20 units 330 (a pair of the fourth inorganic material layer 310 and the fifth inorganic material layer 320) were formed on the resin film 101.

### 8) WVTR Measurement

A WVTR of the three third barrier films 300 prepared from the process 7) was measured by using a water vapor transmission measurement device AQUATRAN, which is a product of MOCON.

### Example 4

A substrate corresponding to a barrier film for an electronic device, according to the third barrier film 300, was formed by the following processes. In the present experiment, the resin film 101 was positively charged, and the negatively charged fourth inorganic material layer 310 and the positively charged fifth inorganic material layer 320 were alternately stacked on the resin film 101.

### 1) Washing of Resin Film 101

A PET film having a thickness of 0.1 mm was prepared as the resin film 101. The resin film 101 was washed with a detergent and pure water and dried by using an air blower.

### 2) Preparation of Tabular Inorganic Particle Dispersion

0.5 g of Kunipil-D36, which is a product of Kuminine industry and is a montmorillonite (MMT), was added to 1 L of pure water, and stirred by using a commercially available agitator (KNS-T1, a product of Azwon) for one day. By doing so, a tabular inorganic particle dispersion in which a tabular inorganic particle was dispersed was prepared

### 3) Preparation of Binder Particle Aqueous Solution

An aqueous solution having 30 mmol/L of AlK(SO₄)₂ was prepared.

### 4) Charging of Resin Film 101

The resin film 101 washed in the process 1) was immersed in an ethanol solution having 10 millimoles per liter (mmol/L) of 3-aminopropyltriethoxysilane (APTES) for 30 minutes. Thereafter, the resin film 101 was washed with ethanol and pure water and dried by using an air blower. By doing this, the resin film 101 was positively charged.

### 5) Formation of the Fourth Inorganic Material Layer

The resin film 101 charged in the process 4) was immersed in the tabular inorganic particle dispersion prepared in the process 2) for 15 minutes, and then sufficiently washed with pure water, and dried by using an air blower. By doing so, the fourth inorganic material layer 310 was formed.

### 6) Formation of Second Inorganic Material Layer

The resin film 101 on which the fourth inorganic material layer 310 was formed, prepared from the process 5) was immersed in the binder particle aqueous solution prepared from the process 3) for 15 minutes, and then sufficiently washed with pure water, and dried by using an air blower. By doing so, the fifth inorganic material layer 320 was formed.

7) Layer-by-Layer Adsorption

The processes 5) and 6) were repeatedly performed 5, 10, and 20 times to form three third barrier films 300 in each of which 5, 10, and 20 units 330 (a pair of the fourth inorganic material layer 310 and the fifth inorganic material layer 320) were formed on the resin film 101.

### 8) WVTR Measurement

A WVTR of the three third barrier films 300 prepared from the process 7) was measured by using a water vapor transmission measurement device AQUATRAN, which is a product of MOCON.

### Example 5

A substrate corresponding to a barrier film for an electronic device, according to the third barrier film 300, was formed by using the following processes. The present experiment is different from Example 4 in the binder particle. That is, the present experiment is the same as Example 4, except that the process 3) was changed as below. In the present embodiment, three third barrier films 300 were formed and WVTRs thereof were measured.

### 3) Preparation of Binder Particle Aqueous Solution

An aqueous solution having 30 mmol/L of FeK(SO₄)₂ was prepared.

### Example 6

A substrate corresponding to a barrier film for an electronic device, according to the third barrier film 300, was formed by using the following processes. The present experiment is different from Example 4 in the tabular inorganic particle. That is, the present experiment is the same as Example 4, except that the process 2) was changed as below. In the present embodiment, three third barrier films 300 were formed and WVTRs thereof were measured.

### 2) Preparation of Tabular Inorganic Particle Dispersion

First, 1 g of α-ZrP, which is a product of Jeil Rare Element Chemical, was added to 150 mL of pure water, and then stirred by using a commercially available agitator (KNS-T1, a product of Azwon) for one day. 30 mL of an aqueous solution having 150 mmol/L of tetrabutylammonium hydroxide (TBAHO) was added dropwise in small amounts to the stirred mixture while a pH of the ZrP solution was controlled not to exceed 9 to perform layer separation (interlayer exfoliation) of ZrP particles (inorganic layered compound particles). By doing so, a tabular inorganic particle dispersion in which the tabular inorganic particle was dispersed was prepared.

### Example 7

A substrate corresponding to a barrier film for an electronic device, according to the third barrier film 300, was formed by using the following processes. In the present experiment, the resin film 101 was positively charged, and the negatively charged fourth inorganic material layer 310 and the positively charged fifth inorganic material layer 320 were alternately stacked on the resin film 101. Also, for convenience, a layer including a layered double hydroxide compound was the fifth inorganic material layer 320.

### 1) Washing of Resin Film 101

A PET film having a thickness of 0.1 mm was prepared as the resin film 101. The resin film 101 was washed with a detergent and pure water and dried by using an air blower.

### 2) Preparation of Tabular Inorganic Particle Dispersion

0.5 g of Kunipil-D36, which is a product of Kunimine industry and is a montmorillonite (MMT) was added to 1 L of pure water, and stirred by using a commercially available agitator (KNS-T1, a product of Azwon) for one day. By doing so, a tabular inorganic particle dispersion in which a tabular inorganic particle was dispersed was prepared.

### 3) Preparation of Binder Particle Dispersion

20 m L of a mixed aqueous solution including 1 mol/L of sodium chloride, 0.01 mol/L of an acetic acid, and 0.09 mol/L of sodium acetate was added to 20 mg of a layered double hydroxide (LDH) compound prepared from M²⁺ₓM³⁺_{y}(OH)ₙCO₃.nH₂O(M²⁺:Mg, M³⁺:Al, B:CO₃²⁻, x=4.5, y=2, n=13), and the mixture was stirred by using a commercially available mixer (SH-B type, Terasawa) for two days to prepare a binder particle dispersion in which the LDH formed from M²⁺ₓM³⁺_{y}(OH)ₙCl₂.nH₂O(M²⁺:Mg, M³⁺:Al, B:CO₃²⁻, x=4.5, y=2, n=13) was dispersed.

### 4) Charging of Resin Film 101

The resin film 101 washed in the process 1) was immersed in an ethanol solution having 10 mmol/L of 3-aminopropyltriethoxysilane (APTES) for 30 minutes. Thereafter, the resin film 101 was washed with ethanol and pure water and dried by using an air blower. By doing this, the resin film 101 was positively charged.

### 5) Formation of First Inorganic Material Layer

The resin film 101 charged in the process 4) was immersed in the tabular inorganic particle dispersion prepared in the process 2) for 15 minutes, and then sufficiently washed with pure water, and dried by using an air blower. By doing so, the fourth inorganic material layer 310 was formed.

### 6) Formation of Second Inorganic Material Layer

The resin film 101 on which the fourth inorganic material layer 310 was formed, prepared from the process 5) was immersed in the binder particle dispersion prepared from the process 3) for 15 minutes, and then sufficiently washed with pure water, and dried by using an air blower. By doing so, the fifth inorganic material layer 320 was formed.

### 7) Layer-by-Layer Adsorption

The processes 5) and 6) were repeatedly performed 5, 10, and 20 times to form three third barrier films 300 in which 5, 10, and 20 units 330 (a pair of the first inorganic material layer 310 and the second inorganic material layer 320) were formed on the resin film 101.

### 8) WVTR Measurement

A WVTR of the three third barrier films 300 prepared from the process 7) was measured by using a water vapor transmission measurement device AQUATRAN, which is a product of MOCON.

### Example 8

A substrate corresponding to a barrier film for an electronic device, according to the third barrier film 300, was formed by using the following processes. In the present experiment, the resin film 101 was negatively charged, and the positively charged fourth inorganic material layer 310 and the negatively charged fifth inorganic material layer 320 were alternately stacked on the resin film 101.

### 1) Washing of Resin Film 101

A PET film having a thickness of 0.1 mm was prepared as the resin film 101. The resin film 101 was washed with a detergent and pure water and dried using an air blower.

### 2) Preparation of Tabular Inorganic Particle Dispersion

20 mL of a mixed aqueous solution including 1 mol/L of sodium chloride, 0.01 mol/L of an acetic acid, and 0.09 mol/L of sodium acetate was added to 20 mg of a layered double hydroxide (LDH) compound prepared from M²⁺ₓM³⁺_{y}(OH)ₙCO₃.nH₂O(M²⁺:Mg, M³⁺:Al, B:CO₃²⁻, x=4.5, y=2, n=13), and the mixture was stirred by using a commercially available mixer (SH-B type, Terasawa) for one day to prepare a tabular inorganic particle dispersion in which the LDH formed from M²⁺ₓM³⁺_{y}(OH)ₙCl₂.nH₂O(M²⁺:Mg, M³⁺:Al, B:CO₃²⁻, x=4.5, y=2, n=13) was dispersed.

### 3) Preparation of Binder Particle Water-Soluble Solution

An aqueous solution having 10 mmol/L of (NH₄)₂MoO₄ was prepared.

### 4) Charging of Resin Film 101

The resin film 101 washed in process 1) was subjected to a corona treatment using HPS-101, which is a product of Japanese company STATIC, for 10 minutes. By doing so, the resin film 101 was negatively charged.

### 5) Formation of First Inorganic Material Layer

The resin film 101 charged in the process 4) was immersed in the tabular inorganic particle dispersion prepared in the process 2) for 15 minutes, and then sufficiently washed with pure water, and dried by using an air blower. By doing so, the fourth inorganic material layer 310 was formed.

### 6) Formation of Second Inorganic Material Layer

The resin film 101 on which the fourth inorganic material layer 310 was formed, prepared from the process 5) was immersed in the binder particle dispersion prepared from the process 3) for 15 minutes, and then sufficiently washed with pure water, and dried by using an air blower. By doing so, the second inorganic material layer 320 was formed.

### 7) Layer-by-Layer Adsorption

The processes 5) and 6) were repeatedly performed 5, 10, and 20 times to form three third barrier films 300 in each of which 5, 10, and 20 units 330 (a pair of the fourth inorganic material layer 310 and the fifth inorganic material layer 320) were formed on the resin film 101.

### 8) WVTR Measurement

A WVTR of the three third barrier films 300 prepared from the process 7) was measured by using a water vapor transmission measurement device AQUATRAN, which is a product of MOCON.

### Example 9

A substrate corresponding to a barrier film for an electronic device, according to the third barrier film 300, was formed using the following processes. The present experiment is different from Example 4 in that an adsorption layer was further formed. That is, the present experiment is the same as Example 4, except that the process 4) was changed as below. In the present embodiment, three third barrier films 300 were formed and WVTRs thereof were measured.

### 4) Charging of Resin Film 101

Akuamika NL100A, which is a product of AZ Electronic Materials Company, was spin coated on the resin film 101 washed in the process 1) by using MS-A150, which is a product of Mikasa Company. Then, the resin film 101 was cured at a temperature of 120° C. for 1 hour, and subsequently, at a temperature of 95° C. and at a humidity of 80% for 3 hours. By doing this, a silica layer having a thickness of about 0.2 μm was formed as an adsorption layer on the resin film 101. The resin film 101 was immersed in an ethanol solution having 10 mmol/L of 3-aminopropyltriethoxysilane (APTES) for 30 minutes. Thereafter, the resin film 101 was washed with ethanol and pure water and dried using an air blower. By doing this, the silica layer was positively charged.

### Comparative Example 3

Three comparative films were formed by using the same process as in Example 4 except for the process 3) of Example 4, and WVTRs thereof were measured.

### 3) Preparation of Binder Particle Aqueous Solution

An aqueous solution having 30 mmol/L of polyarylamine hydroxide (PAH) was prepared.

### WVTR Measurement Results

WVTRs (unit: g/m²/day) of the third barrier films 300 prepared according to Examples 3 to 9 and Comparative Example 3 and the comparative films were measured at a temperature of 40° C. and at a humidity of 90% RH. Results thereof are shown in Table 2 below. Also, in Table 2, the fourth inorganic material layer 310 is indicated as a clay layer.

TABLE 2

| | | WVTR(g/m²/day) | | | | | | | |
|---|---|---|---|---|---|---|---|---|---|
| | | Example | Example | Example | Example | Example | Example | Example | Comparative |
| | | 3 | 4 | 5 | 6 | 7 | 8 | 9 | Example 3 |
| Charging | | Corona | APTES | APTES | APTES | APTES | Corona | APTES | APTES |
| treatment | | | | | | | | | |
| Tabular inorganic | | MMT | MMT | MMT | ZrP | MMT | LDH | MMT | MMT |
| particle layer | | | | | | | | | |
| Second inorganic | | Al | Al | Fe | Al | LDH | Mo Oxide | Al | PAH |
| material layer | | | | | | | | | |
| stack number | 5 | 0.6369 | 0.2543 | 0.2715 | 0.0556 | 0.1650 | 0.2609 | 0.0022 | 0.8526 |
| (pair) | 10 | 0.0549 | 0.0093 | 0.0115 | 0.0275 | 0.0054 | 0.0161 | 0.0012 | 0.3115 |
| | 20 | 0.0090 | 0.0018 | 0.0025 | 0.0146 | <0.0005 | 0.0086 | <0.0005 | 0.1551 |

The WVTRs of the barrier films prepared according to Examples 3-9 were smaller than that of the comparative film of Comparative Example 3. This result shows that the third barrier film 300 for an electronic device has a higher barrier performance than that of the comparative film of Comparative Example 3. For example, to obtain the range of 10⁻² g/m²/day WVTR, even with 20 pairs of layer-by-layer adsorption (that is, 20 units) as in Comparative Example 3, such WVTR values were not able to be obtained. However, in Examples 3-9, such WVTR values were able to be obtained only with 10 or fewer pairs of the layer-by-layer adsorption (that is, 10 units 330) (in some examples, only 5 pairs were sufficient). That is, it was confirmed that the third barrier film 300 formed using the layer-by-layer adsorption may provide higher performance with a smaller stack number than a typical barrier film formed using layer-by-layer adsorption.

Also, the reason that the WVTR of the third barrier film 300 of Example 9 is smaller than the WVTR of the barrier film 300 of Example 4 may be due to the fact that the charging effect was increased by the formation of the silica layer formed according to Example 9 so that the fourth inorganic material layer 310 was more fully adsorbed to the resin film 101.

As described above, regarding the third barrier film 300 for an electronic device, the fifth inorganic material layer 320 includes an inorganic material, and the fifth inorganic material layer 320 and the fourth inorganic material layer 310 are strongly attached to each other by a coulombic force, thereby improving a barrier performance compared to conventional cases.

A barrier film for an electronic device, is a film in which a layer having a gas barrier is formed on a resin film. The barrier film includes a first inorganic material layer that is charged and a second inorganic material layer that has an opposite charge to that of the first inorganic material layer, and the first inorganic material layer is attached to the second inorganic material layer by an electrostatic force. Accordingly, the barrier film has high gas barrier performance, high interlayer adhesion and high reliability.

It should be understood that the exemplary embodiments described therein should be considered in a descriptive sense only and not for purposes of limitation. Descriptions of features, advantages, or aspects within each embodiment should be considered as available for other similar features, advantages or aspects in other embodiments.

What is claimed is:

1. A barrier film for an electronic device, the barrier film comprising:
a resin film; and
a layer-by-layer stack portion comprising a first inorganic material layer and a second inorganic material layer which are alternately disposed on the resin film,
wherein the first inorganic material layer and the second inorganic material layer are oppositely charged.

2. The barrier film of claim 1, wherein the first inorganic material layer comprises a charged inorganic compound that has either a positive or a negative charge, and the second inorganic material layer comprises a charged inorganic layered compound that has a charge opposite to that of the first inorganic material layer.

3. The barrier film of claim 2, wherein the inorganic compound comprises at least one element selected from silicon, aluminum, titanium, and zirconium.

4. The barrier film of claim 2, wherein the inorganic compound comprises an onium salt.

5. The barrier film of claim 4, wherein the onium salt comprises an ammonium salt.

6. The barrier film of claim 2, wherein the first inorganic material layer is a hydrolysis product of at least one selected from an alkoxysilane, metal alkoxide, polysilazane, and alkali silicate.

7. The barrier film of claim 6, wherein the first inorganic material layer comprises a substituent that does not chemically react with an alkoxysilane, a metal alkoxide, a polysilazane, or an alkali silicate.

8. The barrier film of claim 2, wherein the inorganic layered compound comprises at least one selected from a clay mineral, a phosphate compound, and a layered double hydroxide compound.

9. The barrier film of claim 2, wherein the layer-by-layer stack portion comprises a plurality of layers, and an innermost layer that contacts the resin film and an outermost layer that is distal to the resin film are the first inorganic material layers.

10. The barrier film of claim 1, wherein the first inorganic material layer comprises a charged tabular inorganic particle, and the second inorganic material layer comprises a charged second inorganic compound, and the charged second inorganic compound has a charge opposite to that of the charged tabular inorganic particle.

11. The barrier film of claim 10, wherein the second inorganic material layer comprises at least one selected from a metal ion, a metal compound ion, and a tabular inorganic particle.

12. The barrier film of claim 11, wherein the metal ion comprises an ion of at least one metal selected from aluminum, magnesium, potassium, and a polyvalent transition metal.

13. The barrier film of claim 12, wherein the polyvalent transition metal comprises at least one selected from iron, cobalt, and manganese.

14. The barrier film of claim 11, wherein a metal that constitutes the metal compound ion comprises at least one selected from tungsten, vanadium, molybdenum, and titanium.

15. The barrier film of claim 11, wherein the second inorganic material layer comprises a charged second tabular inorganic particle that is a product of layer-separating a layered double hydroxide compound.

16. The barrier film of claim 10, wherein the first inorganic material layer comprises a charged first tabular inorganic particle that is negatively charged, and the second inorganic material layer is positively charged.

17. The barrier film of claim 16, wherein the first tabular inorganic particle is obtained by layer-separating at least one selected from a clay mineral and zirconium phosphate.

18. The barrier film of claim 17, wherein the clay mineral comprises at least one selected from mica, bermiculite, montmorillonite, iron montmorillonite, beidellite, saponite, hectorite, and stevensite.

19. The barrier film of claim 18, wherein the clay mineral comprises montmorillonite.

20. The barrier film of claim 16, wherein the first tabular inorganic particle is a product of layer-separating zirconium phosphate.

21. The barrier film of claim 10, wherein the barrier film further comprises an adsorption layer that is disposed on the resin film to allow the resin film to adsorb onto the layer-by-layer stack portion.

22. The barrier film of claim 21, wherein the adsorption layer comprises at least one selected from silica and alumina.

23. The barrier film of claim 21, wherein the adsorption layer has a charge which is opposite to that of a layer of the layer-by-layer stack portion, the layer of the layer-by-layer stack portion being adsorbed on the adsorption layer.

24. The barrier film of claim 23, wherein the adsorption layer is charged by contacting with a silane coupling agent.

25. The barrier film of claim 1, wherein the barrier film is a substrate for an electronic device.

26. A method of forming a barrier film, the method comprising:
combining a framework forming material and a sol-gel material having a substituent capable of forming an onium ion to form a first solution;
disposing the first solution on a substrate to form a first inorganic material layer;
dispersing a clay in water to form a second solution;
contacting the first inorganic layer with the second solution to form a second inorganic material layer on the first inorganic material layer; and
washing the first and the second inorganic material layers to form the barrier film.

27. The method of claim 26, wherein the framework forming material is at least one selected from an alkoxysilane, a metal alkoxide, a polysilazane, and an alkali silicate.

28. The method of claim 27, wherein the alkoxysilane is a tetraalkoxysilane.

29. The method of claim 26, wherein the sol-gel material is at least one selected from an alkoxysilane, metal alkoxide, polysilazane, and an alkali silicate; and the substituent capable of forming an onium ion is at least one selected from —NR₂, —SR, —PR₂, wherein each R is independently hydrogen or an alkyl group.

30. The method of claim 26, wherein the first solution further comprises water and an acid.

31. The method of claim 26, further comprising washing the first inorganic material layer by contacting with at least one selected from water and an alcohol.

32. The method of claim 31, further comprising drying the first inorganic material layer.

33. The method of claim 26, wherein the clay is at least one selected from mica, bermiculite, montmorillonite, iron montmorillonite, beidellite, saponite, hectorite, and stevensite.

34. The method of claim 26, further comprising drying the second inorganic material layer.

35. The method of claim 26, further comprising repeating the disposing, the dispersing, the contacting, and the washing to dispose another first inorganic layer and another second inorganic material layer on the second inorganic material layer.

36. The method of claim 26, wherein the framework forming material comprises at least one selected from an alkoxysilane, a metal alkoxide, a polysilazane, and an alkali silicate, and at least one selected from an alkoxysilane, a metal alkoxide, a polysilazane, and an alkali silicate that comprises a substituent that does not react with the alkoxysilane, the metal alkoxide, the polysilazane, or the alkali silicate.

37. The method of claim 36, wherein the substituent that does not react with the alkoxysilane, the metal alkoxide, the polysilazane, or the alkali silicate is an alkyl group.

38. A method of forming a barrier film, the method comprising:
treating a surface of a substrate to charge the surface;
dispersing a tabular inorganic particle to prepare a dispersion;
disposing the dispersion on the substrate to form a first inorganic material layer;
forming a binder particle solution comprising a positively charged metal ion, a positively charged metal compound ion, and a positively charged tabular inorganic particle; and
contacting the first inorganic material layer and the binder particle solution to dispose a second inorganic material layer on the first inorganic material layer; and
washing the first inorganic material layer and the second inorganic material layer to form the barrier film.

39. The method of claim 38, wherein the treating comprises corona, ultraviolet ozone, or electron beam treatment.

40. The method of claim 38, wherein the tabular inorganic particle is a clay or zirconium phosphate.

41. The method of claim 38, further comprising repeating the disposing and the contacting to form another first inorganic layer and another second inorganic layer on the second inorganic layer.

42. The method of claim 38, wherein the tabular inorganic particle is an exfoliated clay or a layered double hydroxide compound.
